(19) United States
(12) Patent Application Publication
(10) Pub. No.: US 2009/0171876 A1
(43) Pub. Date: Jul. 2, 2009

(54) Cover type controlled graph rewriting based parallel system for automated problem solving

(76) Inventor: Seppo Ilari Tirri, Helsinki (FI)

Correspondence Address: SEPPO ILARI TIRRI, Kaenkuja 8 D 19, FI-00500 Helsinki, FI

(21) Appl. No.: 12/005,402

(22) Filed: Dec. 27, 2007

(51) Int. Cl. G06N 5/02

(52) U.S. Cl. 706/46

(57) ABSTRACT

The invention gives desired algorithmic solutions, even impossible to derive denumerably from preceding ones, as transducers for any kind of problem, e.g. groups of equations or construction puzzles with variables unlimited even by type. The invention treats problems as triples of a mother graph as the subject of the problem, a solving determining recognizer and limit demands for proper solution types. The invention disperses the mother graphs into abstract partial problems regarding chosen interacting rewriting types with mutual relations controlling profoundness in memory hunting, and by bijective partitions creates abstract sisters for those conceptual graphs. As solutions for the examined problems are micros for the parallel transducers of macros of known solving transducers having common parts with substances of those macros and being not necessarily limited to reducing ones. All conceivable solutions are obtained interacting rewrite type being right sides distinct generalized cover renetting, if the mother graph is denumerable and contents in iteration are not expanded. As an exact universal mathematical structure of controlling inventiveness the invention can be considered as the prime algorithm of independently programs inventing machines for problem solving.

### FIELD OF THE INVENTION

The invention falls basically in the field of computer implemented inventions wherein more precisely algorithmic solutions, graph rewriting, recognizer-automata, artificial intelligence and universal algebra. Suggested patent class: Artificial Intelligence 706/19,/13,/46.

### BACKGROUND OF THE INVENTION

The whole time widening need of systems is requiring knowledge of common structures in systems before creating fast, exact, controllable and sufficiently comprehensive solving algorithms of problems in those systems. In all human fields in data processing, especially in physics and construction there are numerous environments where the data flow can not be restricted in order to get sufficient model to handle with the tasks, e.g. mathematical equation groups with infinite number of variables allowed to be systems themselves and physical phenomena where solution models would require to allow unlimited dimensions (in the field theories of small quantum particles or in universal large astronomical ones). Models in meteorology and models for handling with populations, biological organizations or even combinations in genetic codes call for common approach in problem solving especially in cases where independent in- or out-data flows are required to be unlimited by numbers or volumes, where controlled memory flow is a key word. Naturally one can imagine numerous other fields where a general model for problem solving would be desirable.

The method of this invention guarantees a universal way to solve problems even in the cases where data components are unlimited by numbers and volumes, and being due to our unlimited handling and altering stages also in the cases where solutions are not possible to detect in a denumerable way derived from preceding solutions. The method takes in use generalized graphs in describing subjects of problems which are thoroughly introduced, and rewriting of graphs is the basis to construct parallel altering transducers as macros of solutions for examined problems. The abstract cover type for original problem in order to control the comprehensiveness of searching process can freely be chosen, to be the most conceivable one, too. Therefore a special effort is focused to deal with the relations between interacting rewriting types and constructing abstract sisters in the most general cases. The validity and appropriateness of the solutions are checked by recognizers and limit demands bounded to the problems.

### BRIEF SUMMARY

First we present necessary preliminary definitions for unlimited, infinite and undenumerable cases, followed by the definitions for the construction of graph for arbitrary number of nodes with in- and outputs. Then we give the exact representation for rewriting systems and transducers, the nodes of which being rewrite systems. The necessary consideration is given to definitions for generalized equations. The definition of problem and its solution is introduced in terms of graph, recognizability and transducers fulfilling limit demands. Then the partition of graph and the abstraction relation between concept graphs are introduced, needed in searching the fitting partial solutions from memory. “Altering macro renetting system”-theorem is introducing the necessary equation matching each step of the solution process between graphs and their substances. Parallel theorem establishes the invariability of the abstraction relation and also the construction for necessary algorithms for abstract sisters. “Process summarization”-figure illustrates the process in constructing the desired transducer for the original mother graph from the known ones in memory. “Abstraction closure”-theorem proves that the obtained solving transducers represent all possible solutions for the problem. Finally we present the extension of the rules in searching solving transducers, in the cases where covers of mother graphs differ from partitions, and in the same time a system to control comprehensiveness of remembrance hunting is introduced. For that purpose cover renetting systems are defined as generalizations of partition ones, and partition is replaced by concept of cover renetting result consisting of sequential parts of cover in depth dimension, partly replaced by each other. By taking to account partition relations cover reversely labelling renetting is used to transform results of “right sides distinct”-cover renetting for mother graphs to partitions of that mother graph generated by generalized partition renetting systems. “Altering macro renetting”-theorem is generalized to macro transducers in regard to “right sides distinct”-cover renetting systems. After introducing characterizations for generalized abstraction relation fitting cover results, parallel and “abstraction closure” theorems are widened to handle also with general interacting cover renetting of original problem.

### BRIEF DESCRIPTION OF THE DRAWINGS

FIG. 5.5.1 (The first page view) is the process summarization figure describing solution process order and the relations between known TD:es and TD:es solving the given problem.

FIG. 1.2.2.01 describes an example of finite graphs.

FIG. 1.2.2.07.1 is an example of closely neighbouring nets.

FIG. 1.2.2.07.2 is an example of nets totally isolated from each other

FIG. 1.2.2.12 is a figure of nodes dominating others.

FIG. 1.2.2.13.1 is an example of OWR-loop.

FIG. 1.2.2.13.2 describes a bush.

FIG. 1.2.4.5.1 describes a transformator graph over a set of realizations.

FIG. 1.2.4.5.2 is the figure of a realization process graph of the transformator graph in FIG. 1.2.4.5.1.

FIG. 1.2.4.5.3 is an example of a transformation graph of the transformator graph in FIG. 1.2.4.5.1.

FIG. 1.3.06 clarifies an apex of a net.

FIG. 1.3.07 is a figure of a broken enclosement of an unbroken net.

FIG. 1.3.10 describes a cover of a net.

FIG. 1.3.11.1 is a figure of a saturating cover.

FIG. 1.3.11.2 is an example of a natural cover.

FIG. 1.3.12 describes a partition of a net.

FIG. 1.5.01 describes an enclosement of a net, where rewrite takes a place in that net.

FIG. 1.5.02.1 demonstrates application of manoeuvre mightiness and manoeuvre letter increasing rules.

FIG. 3.1.6.1 is the description for the proof of “a characterization of the abstraction relation”-theorem 3.1 in the case where the outside arities in the other concept are in neighbouring elements of a partition.

FIG. 3.1.6.2 is the description for the proof of “a characterization of the abstraction relation”-theorem 3.1 in the case where the outside arities in the other concept are in elements of a partition totally isolated from each other.

FIG. 3.1.9.1 describes incomplite images of ‘minimal’ realization process graphs of a TG over a set of TD:es in the class of the abstraction relation.

FIG. 3.1.9.2 describes forming a class of the abstraction relation by transformation graphs outdominated (‘centered’) by substances.

FIG. 3.2.1 describes constructing macro RNS.

FIG. 3.3.4 describes the relation between parallel TD:es.

FIG. 3.4.1 is figuring the tree formation of a denumerable class of the abstraction relation.

FIG. 4.1 is clarifying the nature of the invariability of a relation in processing a pair of TD:es.

FIG. 4.2 is a complicated version of FIG. 4.1 with more than one element in the processed relation.

FIG. 4.3.1 describes a situation of FIG. 4.1, where the relation is compiled by covers.

FIG. 4.3.2 is a figure of a 3-successive net and an effect of rewriting in totally isolated elements of a cover.

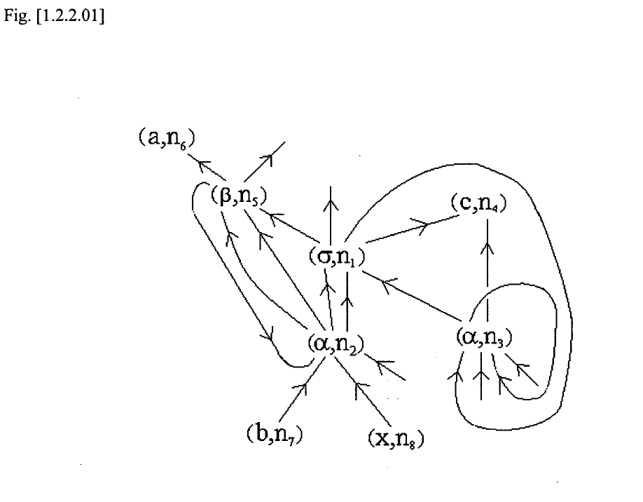

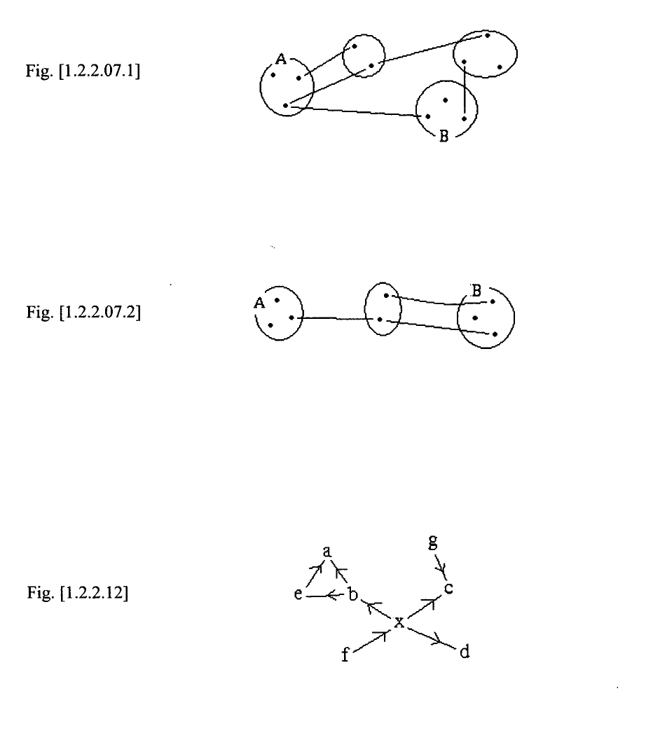

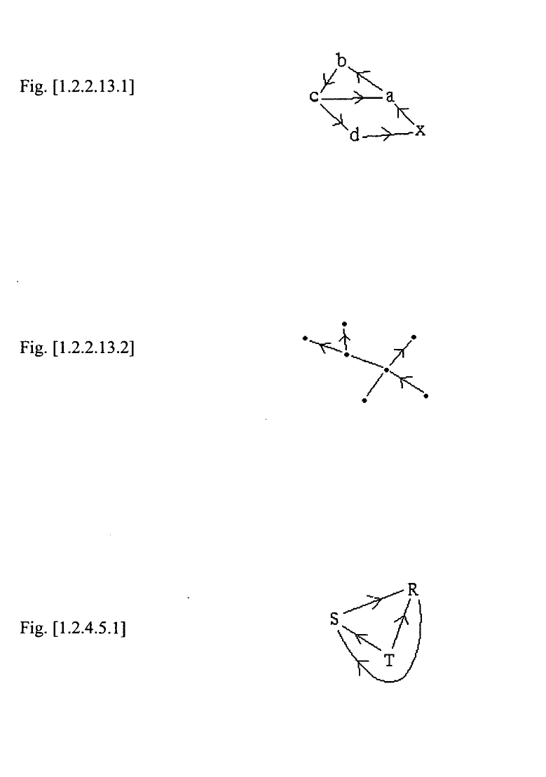

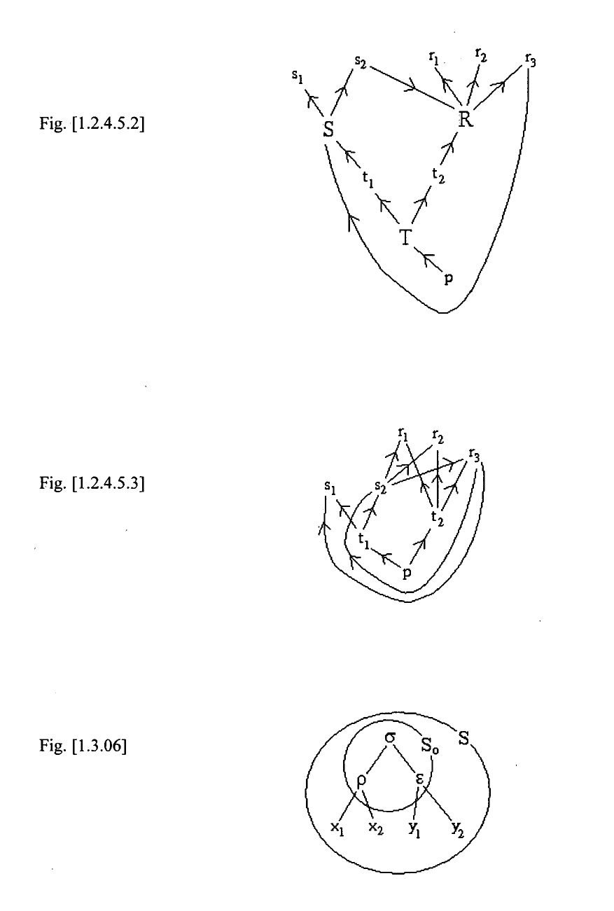

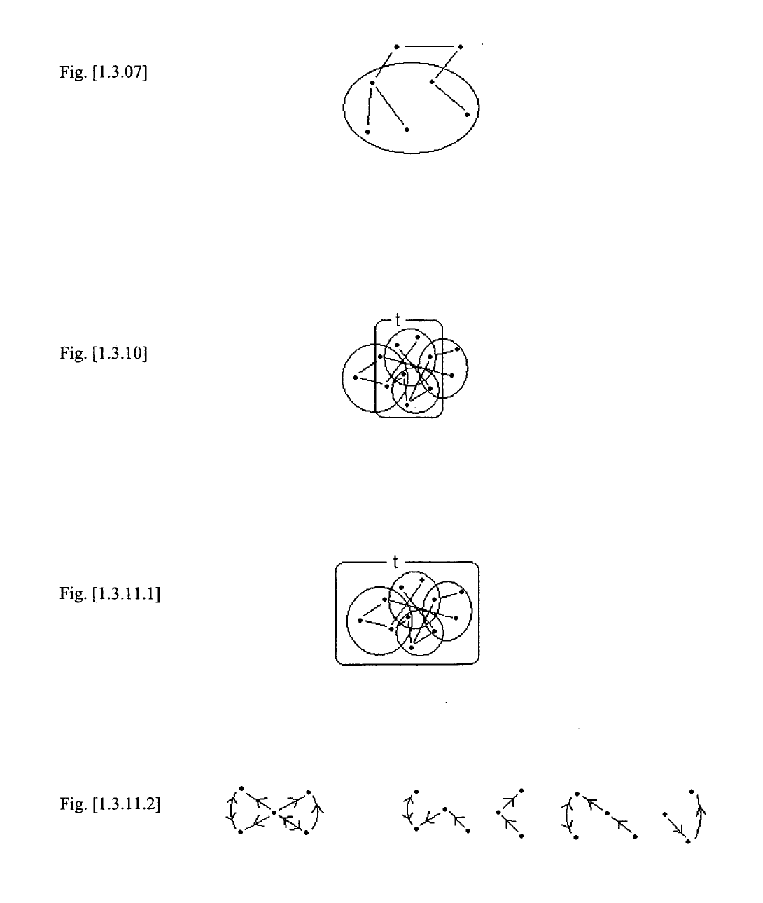

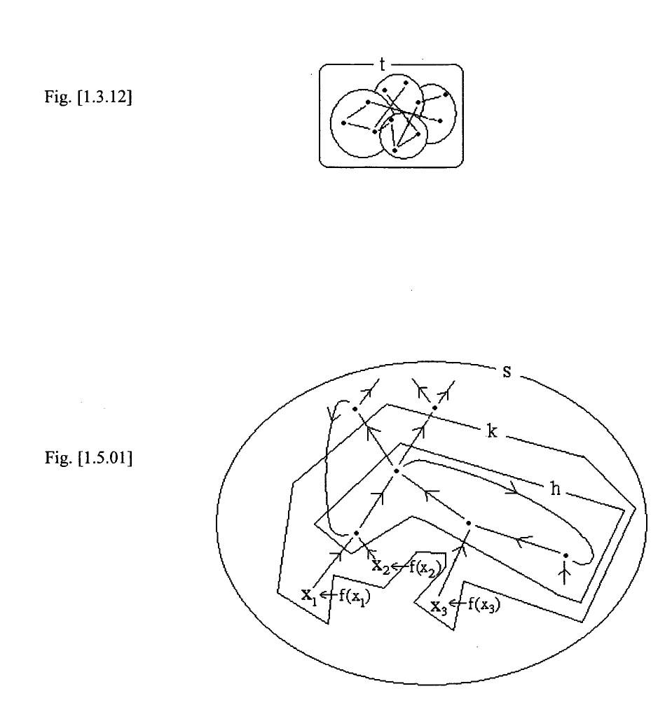

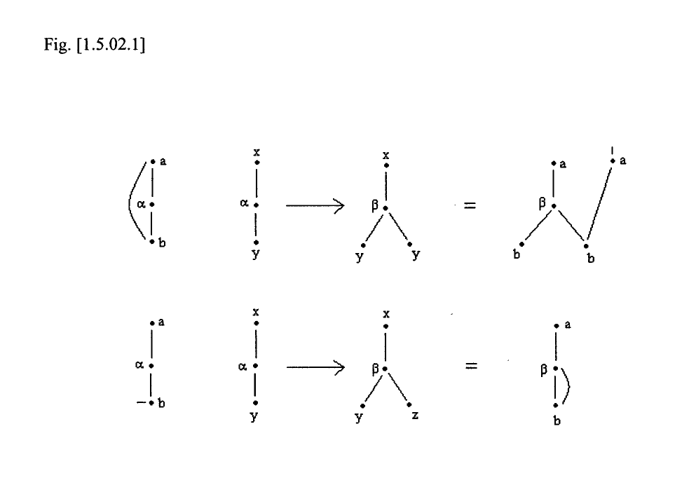

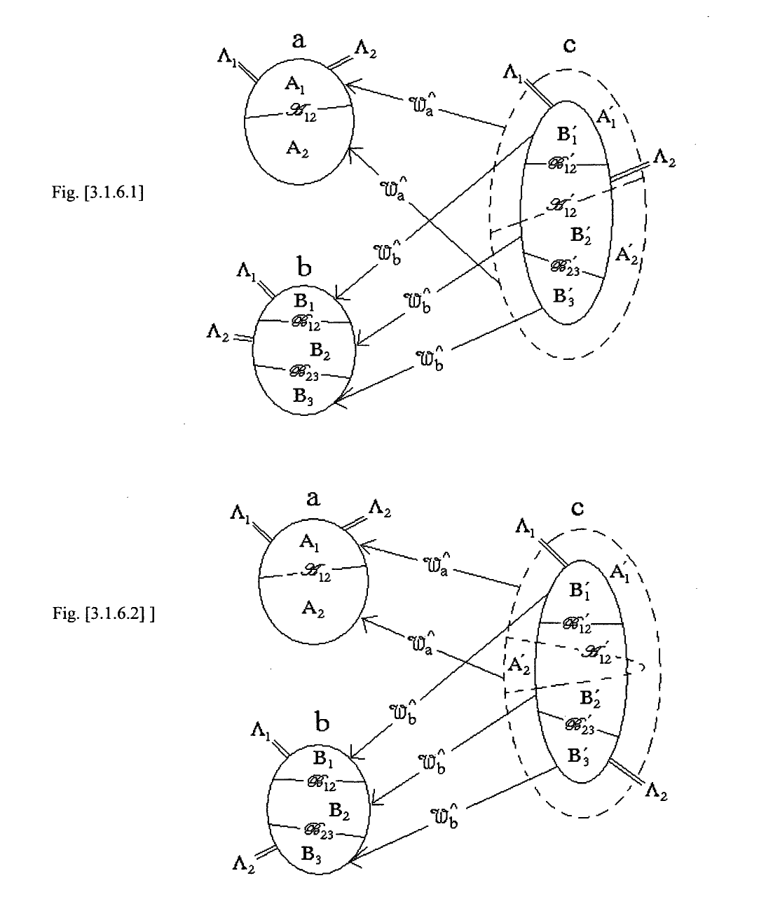

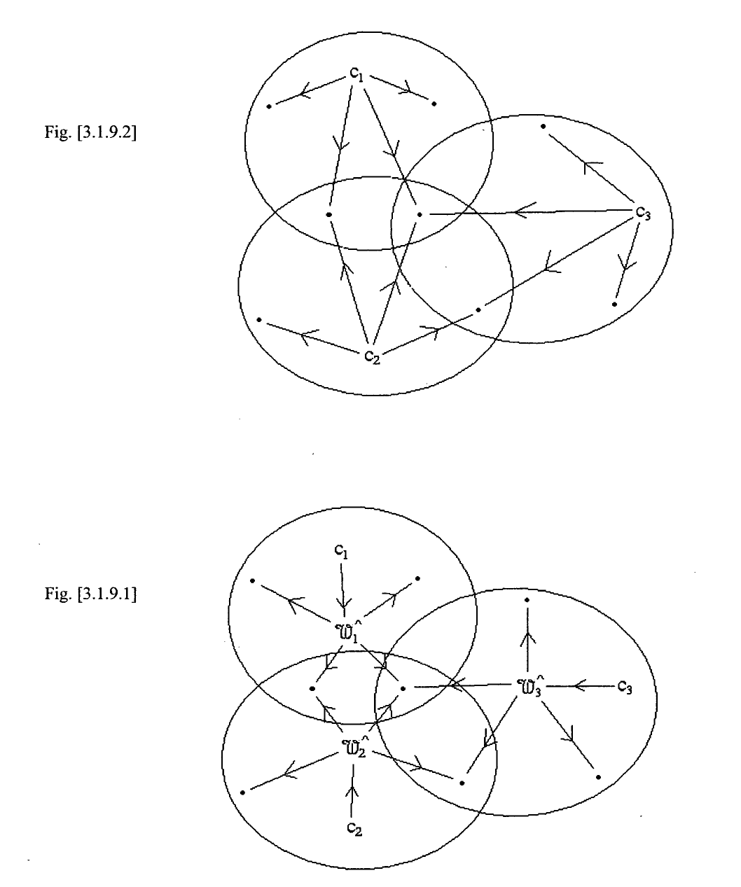

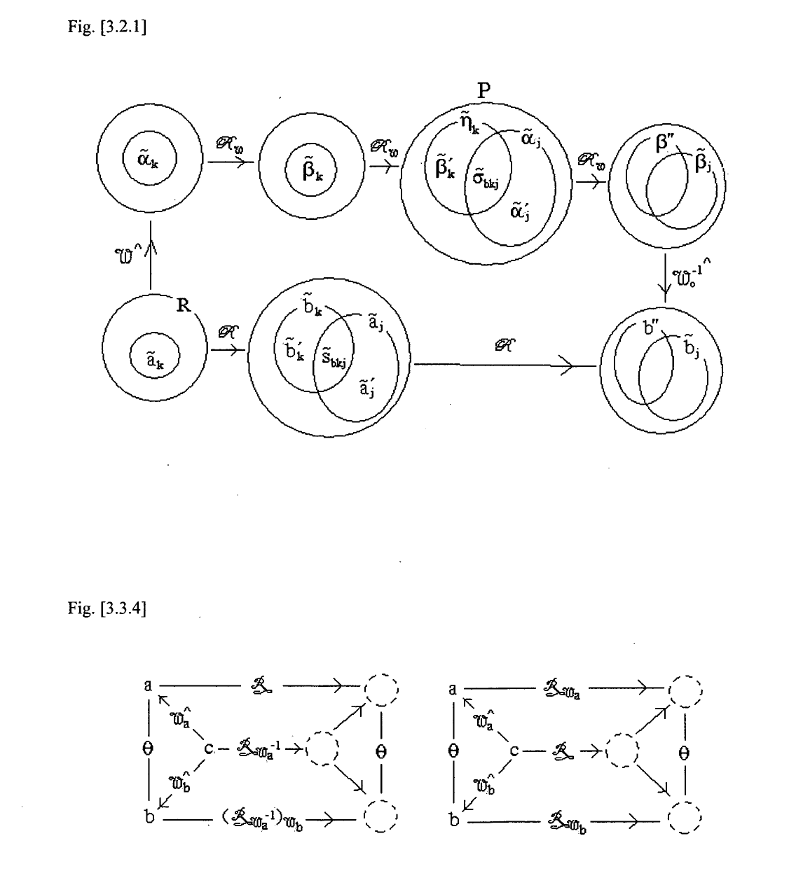

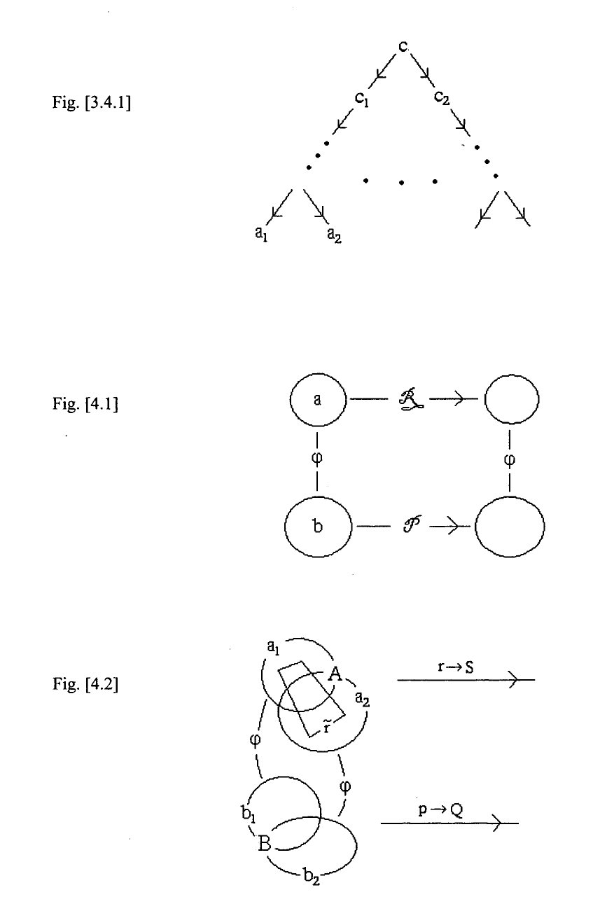

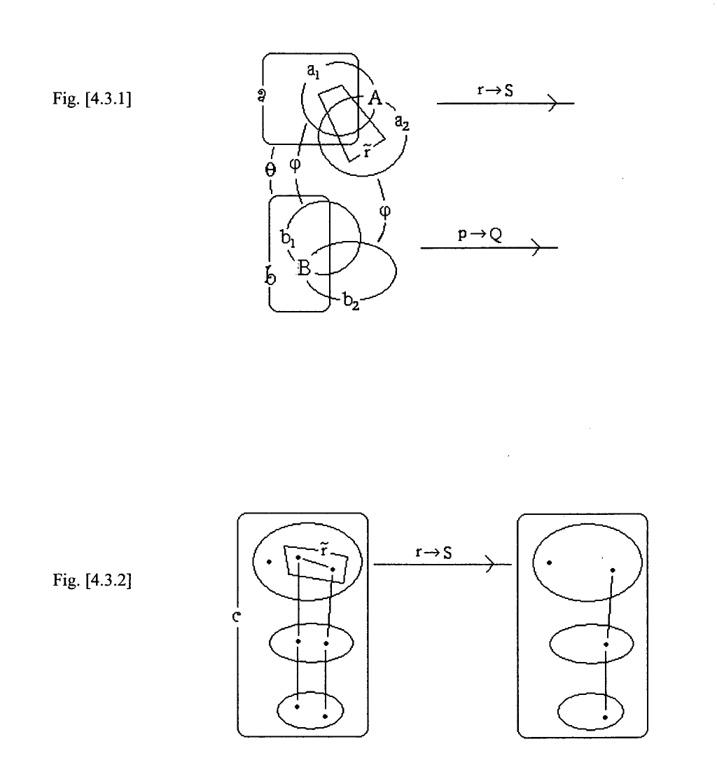

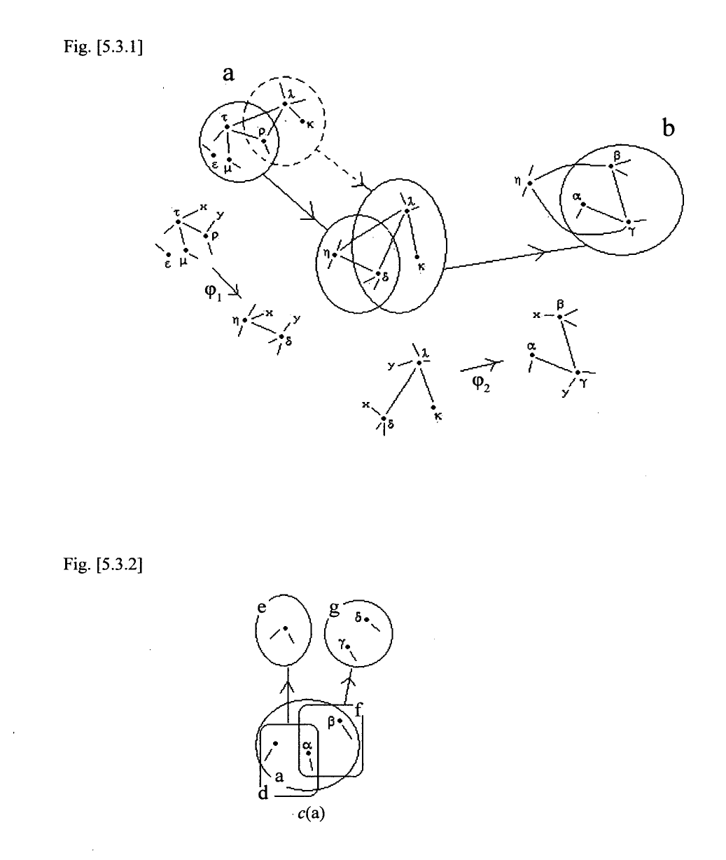

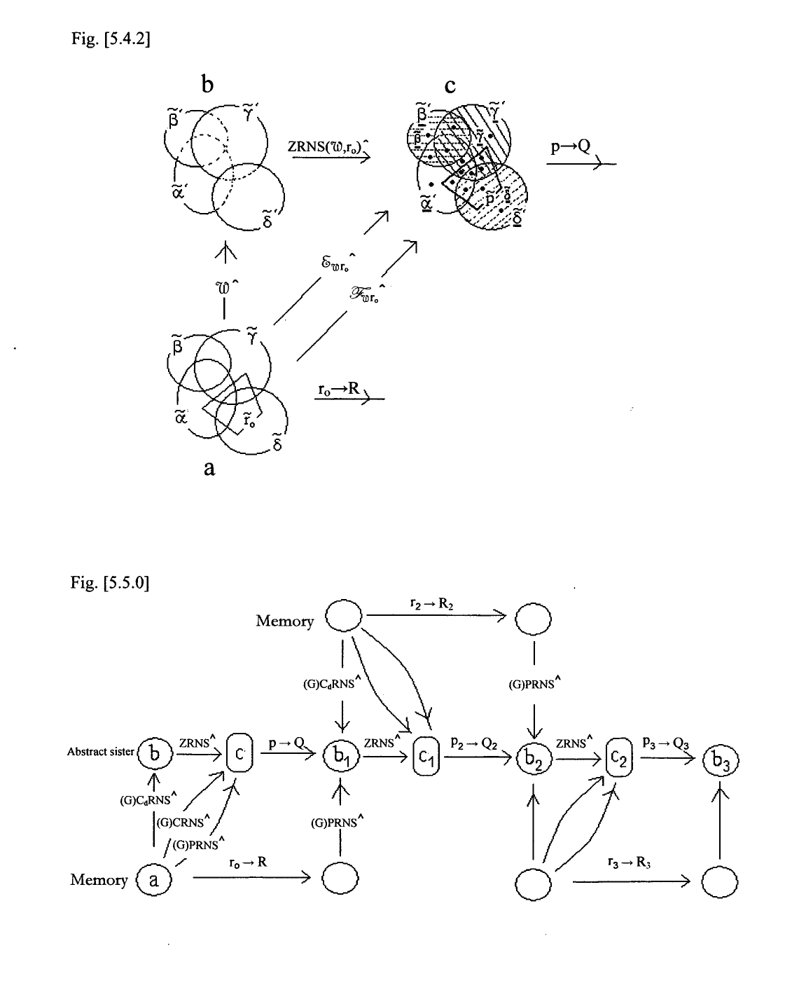

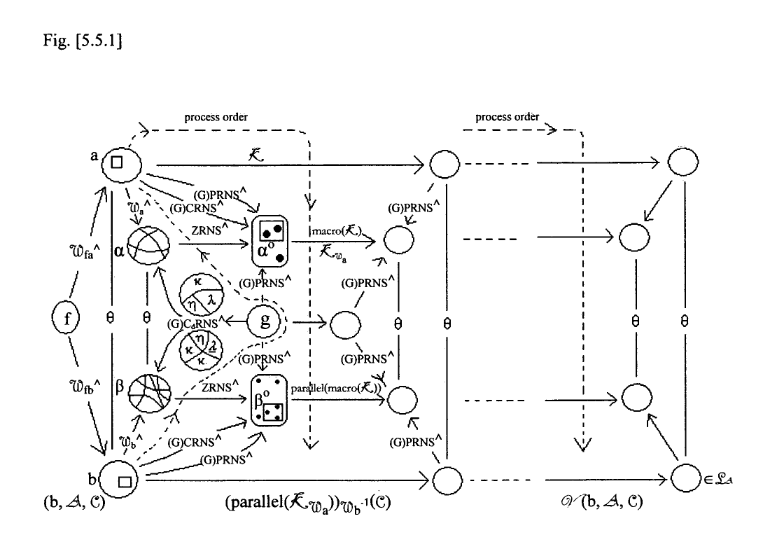

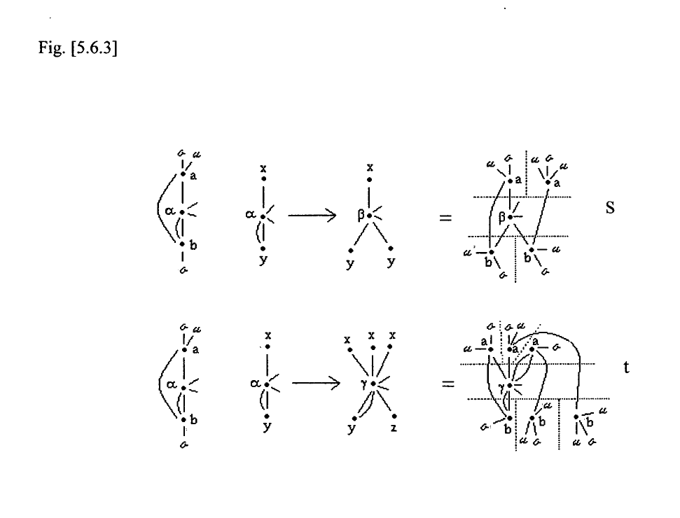

FIG. 5.3.1 illustrates PRNS as a special case of more general cover RNS.

FIG. 5.3.2 is figuring differences between cover orders and partition RNS:es.

FIG. 5.4.2 illustrates transferring information of application of a rule to GPRNS-related form by cover rewriting and reversely labelling RNS.

FIG. 5.5.0 “Memory Hunting” illustrates iterative process of probing known transducers in memory by cover rewriting systems in order to transform them by cover reversely labelling RNS:es.

FIG. 5.6.3 describes a typical phase of iteration in interacting RNS of type GCRNS.

### DETAILED DESCRIPTION OF THE INVENTION

### § 1. Preliminaries

1.1. Sets and Relations

[1.1.01] We regularly use small letters for elements and capital letters for sets and when necessary bolded capital letters for families of sets. The new defined terms are underlined when represented the first time.

[1.1.02] We use the following convenient symbols for arbitrary element a and set A in the meaning:

aε A “a is an element of A or belongs to A or is in A”
a ∉ A “a does not gelong to A”
∃a ε A “there is such an element a in A that”
∃|a ε A “there is exactly one element a in A”
∃|ε A “there exists none element a in A”
∀a ε A “for each a belonging to A” [symbol]
“then it follows that” [symbol]
“if and only if”, shortly “iff”
[1.1.03] {a:*} or (a:*) means a conditional set, the set of all such a-elements which fulfil each condition in sample * of conditions, and nonconditional, if sample * does not contain any condition conserning a-elements.
[1.1.04] Ø means empty set, the set with no elements. A set of sets is called a family. For set [symbol] the notation {aᵢ: i ε [symbol] } is an indexed set (over [symbol] ). Set {aᵢ: i ε [symbol] } is {a}, if aᵢ=a whenever iε [symbol] . If there is no danger of confusion we identify a set of one element, singleton, with its element. It is noticable that {Ø} is a singleton set.
[1.1.05] The number of the elements in set A, mightiness of A, is denoted by |A|.
[1.1.06] A minimal/maximal element of a set is an element which does not contain/is not a part of any other element of the set. The set of the minimal/maximal elements of set A is denoted by min A/max A, respectively.
[1.1.07] For arbitrary sets A and B we use the notations:
A⊂B or B⊃A “A is a subset of B (is a part of B or each element of A is in B) or B includes A”
A⊂B “A is not a part of B (or there is an element in A which is not in B)”
A⊂B or B⊃A “A is a genuine subset of B” meaning “A⊂B and (∃b εB) b ∉ A”
A⊂B “A is not a genuine subset of B”
A≠B “A is not the same as B”
A^{c} or [symbol] A “is the complement of A” meaning set {a:aεA}
A∪B “the union of A and B” meaning set {a:aεA or aεB}
A∩B “the intersection of A and B” meaning set {a:aεA, aεB}. If A∩B=Ø, we say that A and B are distinct with each other, or outside each other.
A\B “A excluding B” meaning {a:aεA, a∉B}. Two sets the intersection of which is empty, is said to be separate from each other.
   [1.1.08] P(A) symbolies the family of all subsets of set A.
   [1.1.09] The set of natural numbers {1,2, . . . } is denoted by symbol |N, and |N₀=|N∪{0}.
   [1.1.10] Notice that for sets A₁ and A₂ and samples of conditions *₁ and *₂
   {a:aεA₁, *₁}⊂{a:aεA₂, *₂}

### if (A₁⊂A₂ and *₁=*₂) or (A₁=A₂ and *₂⊂*₁)

[1.1.11] The notation ∪(Aᵢ: iε [symbol] ) is the union {a:(∃iε [symbol] ) aεAᵢ} and
∩(Aᵢ: iε [symbol] ) is the intersection {a:(∀i ε [symbol] ) aεAᵢ}
   for indexed family {Aᵢ: iε [symbol] }. For any family [symbol] we define:
∪ [symbol] =∪(B:Bε [symbol] )
∩ [symbol] =∩(B:Bε [symbol] )
   [1.1.12] If a set is a subset of the union of a family, we say that the family covers the set or is a cover of the set, and if furthermore the union is a subset of the set, the family saturates the set.
   [1.1.13] Set p of ordered pairs (a,b) is a binary relation, where a is a ρ-domain of b and b is a ρ-image of a. D(ρ)={a:(a,b)ερ} is the domain (set) of ρ (ρ is over D(ρ)), and [symbol] ρ)={b:(a,b)ερ}} is its image (set). Instead of (a,b)ερ we often use the notation aρb. If the image set for each element of a domain set is a singleton, the concerning binary relation is called a mapping. For the relations the postfix notation is the basic presumption (b=aρ); exceptions are relations with some long expressions in domain set or if we want to point out domain elements, and especially for mappings we use prefix notations (b=pa). We define ρ:A [symbol] B, when we want to indicate that A=D(ρ) and B⊃ [symbol] (ρ), and AρB, if (a,b)εp whenever aεA and bεB. When defining mapping ρ, we also can use the notation ρ:a [symbol] b, aεA and bεB. If A⊃B. we say that ρ is a relation in A.

Set {b:aρb} is called the ρ-class of a. Let ρ:A [symbol] B be a binary relation. We say that A′(⊂A) is closed under ρ, if A′ρ⊂A′.

For set [symbol] of relations we denote a [symbol] ={ar:rε [symbol] }, A [symbol] ={ar:aεA, rε [symbol] }. If ρ(A) (={ρ(a):aεA}) is B, we call ρ a surjection. If [ρ(x)=ρ(y) [symbol] x=y], we call ρ injection. If ρ is surjection and injection, we say that it is bijection. If ρ(x)=x whenever xεD(ρ), we say that ρ is an identity mapping (denoted Id). The element which is an object for the application of a relation is called an applicant.

For relations ρ and σ and set [symbol] of relations we define:
the catenation ρσ={(a,c):∃bε(D(σ)∩ [symbol] (ρ)) (a,b)ερ, (b,c)εσ},
the inverse ρ⁻¹={(b,a):(a,b)ερ},
[symbol] ={ρ⁻¹: ρε [symbol] }.
   Let θ be a binary relation in set A. We say that
θ is reflexive, if (∀aεA) (a,a)εθ,
θ is inversive, if θ⁻¹⊂θ,
θ is transitive, if θθ⊂θ,
θ is an equivalence relation, if it is reflexive, inversive and transitive.
   For sets A and B we define
   |A|=|B|, if there is such injection α that α(A)=B,
   |A|<|B|, if there is such injection α that α(A)⊂B, and
   |A|≦|B|, if |A|=|B| or |A|<|B|.
   [1.1.14] We call (a,b) a tuple or an ordered pair, and in general (a₁,a₂, . . . , aₙ) is an n-tuple. For sets A₁,A₂, . . . , Aₙ we define the n-Cartesian power
A₁×A₂× . . . ×Aₙ={(a₁,a₂, . . . , aₙ):a₁εA₁, a₂εA₂, . . . , aₙεA.}.
   [1.1.15] Let {Aᵢ: iε [symbol] } be an indexed family, and let [symbol] be the set of all the bijections joining each set in the indexed family to exactly one element in that set. Family {{r(Aᵢ):iε [symbol] }: rε [symbol] } is called a generalized [symbol] -Cartesian power of indexed family {Aᵢ: iε [symbol] } (Aᵢ may be Ø for some indexes i) and we reserve the notation Π(Aᵢ: iε [symbol] ) for it, and the elements of it are called generalized [symbol] -Cartesian elements. A special example is A×Ø=A. If A=Aᵢ for each iε [symbol] , we denote [symbol] for the generalized [symbol] -Cartesian power of set A. We denote (a₁,a₂, . . . ) the elements of generalized |N-Cartesian power of indexed family A={Aᵢ: iε|N}, where a₁εA₁, a₂εA₂, . . . , and the whole set by A^{N}. Furthermore we denote [symbol] =∪( [symbol] ). Any subset of a generalized [symbol] -Cartesian power is called an [symbol] -ary relation in the generalized [symbol] -Cartesian power. [symbol] is called the Cartesian number of the elements of the generalized [symbol] -Cartesian power. For the number of generalized Cartesian element a we reserve the notation [symbol] (ā).
   [1.1.16] Let [symbol] and [symbol] be two arbitrary sets. We call mapping e[ [symbol] ]:( [symbol] Π(Aᵢ: iε [symbol] )) [symbol] ∪(Aᵢ: iε [symbol] ) a projection mapping, where (Πjε [symbol] ) projection element e[ [symbol] ](j,a) is the element in a belonging to Aⱼ, and we say that j is an arity of e[ [symbol] ]. We denote simply e, if there is no danger of confusion. For elements a and b in Π(Aᵢ: iε [symbol] ) a=b, if and only if e(i,ā)=e(i, b̅) whenever iε [symbol] . We say that a generalized Cartesian element is ≦ another generalized Cartesian element, if and only if each projection element of the former is in the set of the projection elements of the latter and the Cartesian number of the former is less than of the latter.
   [1.1.17] Let Θ be a set of binary relations. Set A is Θ-ordered, if
1° A is a singleton

or 2° there is family [symbol] saturating A and for each A′ε [symbol]
there is set B, B≠A″, and θεΘ such that (A′×B)∩θ≠Ø.
   Set A is innerly ordered, if B⊂A; otherwise outherly ordered. Set A is singleton ordered, if Θ is a singleton and ordinary ordered, if furthermore Θ is an equivalence relation in A. Set A is totally ordered, if [symbol] ={A}, otherwise partially ordered. Finally set A is one-to-one ordered, if it is totally and innerly singleton ordered. Each set which is the image of a bijection of ordered set is ordered, too. E.g. for any set (here B)
D={A: AεP(B), for each EεP(B), E⊂A or A⊂E}
   is ordinary ordered. |N is an ordered set. Set A is denumerable, if it is finite or there exists a bisection: |N [symbol] A; otherwise it is undenumerable.
   [1.1.18] Let (Aᵢ: iε [symbol] ) be an indexed set. Notice that [symbol] may be infinite and undenumerable. If each projection element in a generalized [symbol] -Cartesian element of Π(Aᵢ: iε [symbol] ) is written before or after another we will get a [symbol] -catenation of family (Aᵢ: iε [symbol] ) or a catenation over [symbol] , and the projections of the concerning Cartesian element are called members of the catenation. Notice that also pq is a catenation, if p and q are catenations, and we say that each member of p precedes the members of q and each member of q succeeds the members of p; thus preceding and succeeding defining catenation order among the members of catenations. The member of a catenation preceding/succeeding all other members in the catenation is called the first/the last member in the catenation. A catenation having the first or the last member (the end member of the catenation) has an end. [symbol] is said to be a catenation index. The set of the [symbol] -catenations of A is denoted [symbol] For n ε|N we define the set of the n-catenations of A, [symbol] , such that [symbol] = [symbol] , where H={i:i≦n, iε|N}. EL(A) is the notation for the set of the elements in all catenations in set A. E.g. sequence a₁a₂ . . . aₙ, nε|N, n>1, is a finite catenation. For set H of symbols we define H* (the catenation closure of H) to represent the set of all the catenations of the elements in H. Decomposition d of catenation c is any catenation of the parts of c (the elements of d) such that d=c. For our example, above, d₁d₂, where d₁=a₁a₂ . . . a , d₂=aᵢ₊₁aᵢ₊₂ . . . aₙ, is a decomposition of a₁a₂ . . . aₙ For the catenation operation of sets we agree of the notation:
{a:aεA, *_{A}} {b:bεB, *_{B}}={ab:aεA, bεB, *_{A}, *_{B}}.
   The transitive closure of set [symbol] of relations is the catenation closure of [symbol] including the identity mappings corresponding to the empty catenations. For set A, index set [symbol] and set [symbol] of relations we define:
A [symbol] =(A [symbol] ) [symbol] , whenever iε [symbol] = [symbol] \i and [symbol] = [symbol] .
   [1.1.19] Let G be a set and let A be a smallest set including G such that for set H of relations (operations) in A there is a valid equation A=∪(GH*). We say that [symbol] =(A,H) is H-algebra and G is a set of its generators and A is the set of its elements. If G′⊂ whenever G is a generator set of [symbol] , we call G′ the minimal generator set of [symbol] .

P( [symbol] )=(P(A),\tilde{H}) is the subset algebra of [symbol] , where [symbol] =(A,H) is an algebra, \tilde{H}={\tilde{h}: hεH} is the set of relations, where \tilde{h} is such a relation in P(A) that B\tilde{h}=Bh, whenever B⊂A and hεH.

[1.1.20] For any symbols x and y we define replacement x←y, which means that x is replaced with substitute y. Notation A(x←y) represents an object where each x in A is replaced with y; and A(x←Ø) is an object where x is deleted. Unr(A) means the set of such elements in A that are not replaced by anything.
1.2. Net and graph

### [1.2.1] Denumerable Net

[1.2.1.1] The set of in- or outputs (forming in-/out arity alphabets [disjoined with each other] or inugle-/outglue alphabets) is a subset of an indexed set (e.g. the natural numbers) and the in-/outrank is its mightiness. The arity letters have no in- or outputs in themselves. We reserve symbols X and Y for frontier alphabets, whose letters have exactly one input and output. On the other hand symbols Σ and Ω are reserved for alphabets whose letters are not arity or frontier letters and are called ranked or elementary programme [fitting more to their practical use] letters each of which has or has not arities. Notation inp(Ξ) symbolises the set of the inarity letters of alphabet Ξ, and outp(Ξ) symbolises the set of the outarity letters of Ξ. Furthermore we denote Ψ(Ξ)=(inp(Ξ))∪(outp(Ξ)). If an arity letter is replaced we say that it is occupied. Occ(A,t) means the set of all those arities in set A of arities, which are occupied in situation net t, and Uno(A,t) are reserved for the set of all those which are unoccupied in net t; if there is no danger of confusion we may drop the situation net in the notations. L(t) symbolises the set of the letters in symbol t. If it is necessary to avoid confusion, we use notation L°(t) to indicate the set of the letters of t excluding arities, and Ψ(L°(t)) symbolizes the union of the sets of the arity letters in the elements of L°(t).
[1.2.1.2] Let A be a set and let Ξ be a set of frontier and ranked letters. For each ξεΞ we define the realization anchoring relations:
E_{ξ}: ξ(i←aᵢ: iεinp ξ, aᵢεA) [symbol] A^{outrankξ}.
   Let f be a bijection joining each ξεΞ to some relation E_{ξ}. Let Ā be the union of all Cartesian powers of set A, and we reserve that notation for it also in the following. Notation [symbol] =(Ā,Ξ,f) is called a Ξ-algebra, with A as its generator set and f its binding mapping over Ξ.

We denote [symbol] (i←aᵢ: iεinp(ξ), aᵢεA)=ξ(i←aᵢ: iεinp(ξ), aᵢεA)f(ξ).

Now for each ranked letter ξ we define operation [symbol] ( [symbol] -realization of ξ) as such a relation: [symbol] :A^{inrank(ξ)} [symbol] A^{outrank(ξ)}

that
ā [symbol] = [symbol] (i←e[inp ξ](i,ā): iεinp(ξ)), whenever āεA^{inrank(ξ)} and for each frontier letter ξ
a [symbol] =a, whenever aεA.
   [1.2.1.3] Now we define denumerable (ΣX-)net (DN) inductively as follows:
1° each DN has positions (possibly none) in each DN, and in those positions there can be only one DN at most, p(v₁,v₂) is denoted to be the set of the positions of DN v₂ in DN v₁,
2° each ξεX∪Σ is a DN, and the top of ξ (top(ξ)) is ξ itself,
3° t=σ(i←(\vec{k}ᵢ,(w(sᵢ,nᵢ))), j←(kᵢ, (w(sⱼ,nⱼ))): iε [symbol] , jε [symbol] ) is DN,
   and the top of t (top(t)) is σ, whenever
   σεΣ, [symbol] ⊂inp(σ), [symbol] ⊂outp(σ), and
   for each i ε [symbol] k̅ᵢ εoutp(L(w(sᵢ,nᵢ))), for each j ε [symbol] kⱼ εinp(L(w(sⱼ,nⱼ))),
   where w is a mapping which joins for each iε [symbol] the pair of DN sᵢ and position nᵢ in sᵢ to the DN having that position in sᵢ; correspondingly for each jε [symbol] . It is defined that for each iε [symbol] there is only one ( k̅ᵢ,(w(sᵢ,nᵢ))) at most; correspondingly for each jε [symbol] .

We say that inarity i in σ is occupied by w(sᵢ,nᵢ) in outarity k̅ᵢ, and outarity j in σ is occupied by w(sⱼ,nⱼ) in inarity kⱼ. We say that position nᵢ in t is below, specifically next below σ in t and position nⱼ in t is above, specifically next above σ in t. The set of the positions of w(sᵢ,nᵢ) in t is defined to be the set of the positions of top(w(sᵢ,nᵢ)) in t. If position p₁ in DN s is next below position p₂ in s and p₂ is below p₃ in s, we define that p₁ is below p₃. “Above” is defined analogously. DN v₁ is below/next below DN v₂ in DN v, if a position of v₁ in v is below/next below a position of v₂ in v. “Above” is defined analogously with below. Nets v₁ and v₂ are denumerable subnets (DSN) of net v. Next below/next above is denoted shortly by [symbol] and below/above is denoted by [symbol] .

[1.2.1.4] We say that the set of all denumerable nets is the set of the elements of free algebra_over the minimal generator set X, denoted [symbol] (X), the operations of which are called operators. The set of the elements in [symbol] (X) is denoted by F_{Σ}(X). Σ-algebra (generated by Σ) is symbolized by [symbol] and F_{Σ} is the set of that algebra (elements of which are called denumerable ground nets).

### [1.2.2.] Graph

[1.2.2.01] Nets can be described by graphs, where the connections between in- and outputs of nets, that is replacements, are denoted by dendrites, and where graph actually can be seen as triple (A, [symbol] ,f), where A is a set of pairs (node, its arity), [symbol] is a set of dendrites, and f: [symbol] αA×A is a bisection connecting the dendrites to the pairs, the arity of the first element in a pair is occupied with the node of the second element in its arity via a dendrite. In other words a dendrite connects exactly one occupied outarity to exactly one occupied inarity. The frontier and ranked letters in graphs are called nodes. See FIG. 1.2.2.01 of finite graph v, where the arity letters connected with dendrites are dropped from the figure. Symbol b is a ranked letter with no inputs, and x is a frontier letter. Symbols a, c, α, β, and σ are ranked letters, nᵢ, i=1, 2, . . . , 8 are positions of nodes and e.g. p(v,α)={n₂,n₃}.

If we write a graph by emitting some dendrites of it and nodes connected to them as well, we have written an incomplite image of it. A set of graphs is called a jungle.

FIG. 1.2.2.01 describes an example of finite graphs.
[1.2.2.02] The dendrites of graphs which are equiped with directions: from outarity to inarity, are called directioned, otherwise directionless. If all dendrites in a graph are directioned, we say the graph is directioned, otherwise it is directionless. We speak of an out-/indendrite of a node, if it is connected to out-/inarity of that node.
[1.2.2.03] If a dendrite connects outarity ν in node a to inarity μ in node b, the dendrite can be denoted by pair [symbol] (a,ν),(μ,b) [symbol] , and nodes a and b are called nodes of the dendrite, and the dendrite is an outdendrite of node a and an indendrite of node b. An in- and outdendrite of the same node are said to be successive to each other. The dendrites between the same two nodes are parallel with each other.
[1.2.2.04] We say that an arity which is occupied by a net is occupied via the dendrite between that arity and the net.
[1.2.2.05] Net s is said to be out-/inlinked to net t, if s has an out-/inarity of a node which is connected to an in-/outarity of a node in t with an out-/indendrite (so called out-/inlink of s). In other words: an arity of a node in one net is occupied with a node in the other net via a dendrite. If furthermore those nets have no shared nodes, we say they are neighbouring each other. A set of the neighbouring nets of a net is called a touching surrounding of the net.
[1.2.2.06] If dendrite [symbol] (a,v),(μ,b) [symbol] is an outlink from net s to net t, it can be denoted [symbol] s(a,ν),t(μ,b) [symbol] or simply [symbol] s,t [symbol] . A dendrite which connects two nodes in a net is an inward connection/inward link of the net. If the inward connections in a net are directed, the net is directional and if the inward connections are directionless, the net is directionless. If only a part of the inward connections are directed, the net is partly directed. The out-/indendrites of a net which are not inward connections are called out-/in-outward connections/links of the net. If a net has no outward links, it is said to be closed.
[1.2.2.07] Nets are said to be isolated from each other, if there is a net distinct from them and neighboured by them. We say that nets being neighboured by each other are linked directly, and nets being isolated from each other are linked via isolation. If the mightiness of the set of the direct links for a net is m, we speak of m-neighbouring of the net.

If nets are neighbouring each other such that they are not isolated from each other, we say they are closely neighbouring each other. See FIG. 1.2.2.07.1, where A and B are closely neighbouring each other.

FIG. 1.2.2.07.1 is an example of closely neighbouring nets.

If nets are isolated from each other, but are not neighbouring each other, we say they are totally isolated from each other. See FIG. 1.2.2.07.2, where A and B are totally isolated from each other.

FIG. 1.2.2.07.2 is an example of nets totally isolated from each other.

Net s is t-isolated, if the nodes of t are totally isolated from each other by the nodes of s, and inversely.

[1.2.2.08] The set of the links connecting two nets to each other is called the border between those nets. The border may be empty, too. The union of the set of the borders between a net and all other nets distinct from that net is called simply the border of the net.
[1.2.2.09] The nets which are not linked to each other are disjoined with each other. If nets have no common nodes, they are said to be distinct from each other.
[1.2.2.10] The nets of a jungle which are inlinked inside the jungle, but not outlinked, are in-end nets and at in-end positions in the jungle, and the nets outlinked inside a jungle, but not inlinked, are out-end nets and at out-end positions in the jungle. The union of the in-end nets and the out-end nets in a jungle is called the rim of the jungle.
[1.2.2.11] A denumerable route (DR) between nets are defined as follows:
1° any link between two nets is a route between those nets, and
2° if Q is a DR between net s and t and, r is a DR between t and net u, then Qr is a DR between s and u.

DR can also be seen as an inversive and transitive relation in the set of the nets, if “link” is interpreted as a binary relation in the set of the nets. Any route can also denoted by the chain of the nets linked by the dendrites in the route.

[1.2.2.12] We define an in-/out-one-way DR (in-/out-OWR) between nets as transitive relation (“link” is a binary relation) among the set of the nets as follows:
1° any link which is an in-/outlink of net s and on the other hand an out-/inlink of net t is an in-/out-OWR from s to t, and
2° if Q is an in-/out-OWR from net s to net t and r is an in-/out-OWR from t to net u, then Qr is an in-/out-OWR from s to u, and we say that s in-/out-dominates u and u out-/in-dominates s. See FIG. 1.2.2.12, where x is out-dominating a,b,c,d and e but not f or g; b in-dominates only x and f.
   FIG. 1.2.2.12 is a figure of nodes dominating others.
   [1.2.2.13] An DR from a net to itself is a loop of the net, and outside loop, if furthermore in the route there is a link to outside the net; otherwise it is an inside loop of the net. The loop where each dendrite is among the links of the same jungle, is an inside loop of the jungle. Loops can be directed or directionless depending on the links in it. See FIG. 1.2.2.13.1, where xabcd is the outside OWR-loop of x.
   FIG. 1.2.2.13.1 is an example of OWR-loop.
   A bush is a jungle which has no inside loops. FIG. 1.2.2.13.2 of a bush. A bush is called elementary, if it has no parallel dendrites.
   FIG. 1.2.2.13.2 describes a bush.
   [1.2.2.14] If A is the set of routes between nets s and t, we say that s and t are A- or |A|-routed with each other.

### [1.2.3] Generalized Net

[1.2.3.1] A set of denumerable nets is generalized net (GN) (simply net in the following, if there is no danger of confusion), and unbroken, if each net of that set, except the ones in a rim of the set which are only inlinked, is outlinked to some other net or nets in that set; otherwise it is broken. If none node of that set is neighbouring with any other, we say that the GN is totally broken. E.g. any set, the elements of which seen as nodes, can be seen as a totally broken GN and is called degenerated. Notice that an unbroken generalized net is one-to-one ordered. An unbroken net where each node is connected to exactly one node is a chain.
[1.2.3.2] Nets are defined to be the same, if they have the same graph to describe them, and on the other hand in that case they can be seen as representatives of the graph. In the following we use without any special remarks terms “net” and “graph” in the same meaning and do not specify alphabets in graphs, if there is no danger of confusion. Otherwise the graph for net t is notated by g(t) and the set of the representatives for graph v is denoted by [symbol] (v). A set of GN:es is called a jungle.
[1.2.3.3] The set of the positions of a GN consists of the positions of the DN:es of the GN. Let P₁ and P₂ be two arbitrary sets of positions. We define and denote that P₁ [symbol] P₂, if P₁ and P₂ are separate and ∀p₁εP₁ ∃ p₂ ε P₂ such that p₁ [symbol] p₂, and P₁ [symbol] P₂, if ∀p₁εP₁ p₁ [symbol] p₂ whenever p₂εP₂.
[1.2.3.4] Let s and t be two arbitrary GN:es. If for each denumerable net of s, there is such a DN of t, that the former is a DSN of the latter, we say that s is a generalized subnet (GSN) of t. The set of the graphs of jungle T of nets is denoted by g(T). The jungle of the subnets of all nets in jungle T is denoted sub(T). Notice that each nonsingleton jungle can be seen as a broken GN. A set of subnets of the nets in jungle T is called a subjungle of T.
[1.2.3.5] For net v, v|p (an occurrence), is denoted to be the subnet of v having or “topped at” position p in v. The set of all subnets in v is denoted by sub(v). Subnets which are letters are called leaves, and the set of all leaves in v is denoted by Leav(v). For net v we denote fron(v) as the frontier letters of v, and rank(v) is the set of all ranked letters in v. A down-/up-fntier net of DN v, down-/up-fronnet(v), is such a denumerable subnet of v, whose occurrence is next below/next above v (at so called down-/up-fiontierposition of v). We denote Frd(v) meaning the set of all down-frontier nets of v, and Fru(v) is the set of all up-frontier nets of v, and Fᵣ(v) means the set of all frontier nets of v.
[1.2.3.6] We define the height of net t, hg(t), by the following induction:
1° hg(t)=0, if t is a frontier or ranked letter
2° hg(t)=1+max{hg(s):sεFᵣ(t)}, if t is not a frontier or ranked letter.
   [1.2.3.7] The set of all positions of subnet t in jungle T is denoted by p(T,t). The set of the positions in jungle T is denoted p(T). For an arbitrary net t the positions of the outside arities of t, (OS(t)), means the set of the positions of all those arities of the elements in L(t) which are not occupied by anything in that particular net t. Furthermore for t we define in/-outdegee (δᵢₙ(t)/δₒᵤₜ(t)) as the mightiness of the set of the in-/outarities in all nodes of t.
   [1.2.3.8] We say that net is finite, if the number of denumerable nets and frontier and ranked letters in it are finite number. The set of all GN:es is denoted by G(Σ,X), if the set of its DN:es is F_{Σ}(X). Notice that studying infinitenesses the crucial thing is ordering and there are nets the most valuable tools.
   [1.2.3.9] A net is said to be k-successive, if it can be devided in k totally broken nets by a border. A chain with k nodes is k-successive.

### [1.2.4] Realization of Net

[1.2.4.1] Let [symbol] be a Ξ-algebra with A being the set of its elements and Ξ=X∪Σ. Let t be defined as in the DN-definition. Then we define the [symbol] -realization of t (denoted ( [symbol] )), where [symbol] is a relation in Ā, the [symbol] -operation of t, fulfilling set of conditional demands C [symbol] , and for each aεĀ [symbol] (ā)=w(sⱼ,nⱼ [symbol] (kⱼ←e(j, [symbol] (i←e( k̅ᵢ,w(sᵢ,nᵢ [symbol] (ā)):iε [symbol] )):jε( [symbol] ), if t∉toy.

Notice that Ā={ [symbol] (ā):tεF_{Σ}, āεĀ} and (Ā,{ [symbol] tεF_{Σ}}) is { [symbol] tεF_{Σ}}-algebra. If we chose f(σ) to be an identity mapping for each σεΣ and A=X we shall get a free Σ-algebra [symbol] over X. [symbol] (X)-realization is [symbol] -realization, where A=F_{Σ}(X).

Images of realizations of DN:es can be seen as outrank dimensional objects compounding dimensions being images of realizations of trees (DN:es with only one output) which on their side are inrank dimensional with dimensions being images of realizations of strings (trees with only one input). We call sets of trees forests. The realizations of the trees are mappings.

Tuple ( [symbol] ,C [symbol] ) is the [symbol] -realization of GN, G [symbol] , t, where [symbol] is obtained by replacing each DN in t with the [symbol] -operation of the concerning DN. Net t is called the carrying net for ( [symbol] ) and the set of [symbol] -realizations of the nodes of t is entitled [symbol] -nest of t or the nest of [symbol] , and we say that t and [symbol] are beyond D whenever D is a subset of that nest; we denote G [symbol] (|D). For each Aₒ⊂Āwe define Aₒ( [symbol] )=Aₒ [symbol] , and call Aₒ( [symbol] ) a ( [symbol] )-transformation of Aₒ. For jungle T we denote ( [symbol] )={t( [symbol] ):tεT}. Important examples of realizations are equations, where e.g. symbol “=” is the realization of a ranked letter with two inputs.

[1.2.4.2] Lemma 1.2.1. Each demand or claim can always be presented with realizations of nets.
Proof. Each presentable elementary claim is actually a relation in some algebra. □
[1.2.4.3] Lemma 1.2.2. Any realization of any GN can be presented as a graph.
Proof. Straightforward. □
[1.2.4.4] Let [symbol] be an [symbol] -realization for algebra [symbol] . Two nets are [symbol] -confluent with each other in regard to a relation between them, if their [symbol] -transformations are in that relation with each other.
[1.2.4.5] Let A be a jungle and [symbol] =(Ā,Ξ,f) be a Ξ-algebra. Let p, r₁, r₂, r₃, s₁, s₂, t₁ and t₂ be nets in A, and let R, S and T be [symbol] -realizations of some suitable nets of A. Now we are defining for only descriptive use some special nets by visible manner and example wise: FIG. 1.2.4.5.1 of transformator graph (TG) [symbol] over {R,S,T} (a set of node transformators), denoted TG({R,S,T}). If H is a set of realizations, set K being one of the subsets of H, we say that [symbol] is beyond K whenever [symbol] is TG(H) and we denote TG(|K).
FIG. 1.2.4.5.1 describes a transformator graph over a set of realizations.
FIG. 1.2.4.5.2 of a realization process graph (RPG) of [symbol] , where pT=(t₁,t₂), (r₃,t₁)S=(s₁,s₂) and (s₂,t₂)R=(r₁,r₂,r₃).
FIG. 1.2.4.5.2 is the figure of a realization process graph of the transformator graph in FIG. 1.2.4.5.1.
Generally speaking: any RPG is a TG-associated net, where each net as a node (an element of a transformation) in the RPG is in- and up-connected to at most one [symbol] -realization in the TG. FIG. 1.2.4.5.3 of a transformation graph (TFG) of [symbol] .
FIG. 1.2.4.5.3 is an example of a transformation graph of the transformator graph in FIG. 1.2.4.5.1.
1.3. Substitution and enclosement
[1.3.01] Let T be an arbitrary jungle. Notation T(P [symbol] A:*) is the jungle which is obtained by replacing (considering conditions *) all the subnets of each net t in T, having the position in set P, by each of elements in set A. If each position of set S of subnets of each net t in T is wished to replace by each of elements in A, we write simply T(S←A).
[1.3.02] Suppose we have a monadic mapping that is any mapping λ:Σ [symbol] P(F_{Ω}). Let [symbol] be a Ω-algebra with A being the set of its elements. Then the morphism \tilde{λ}: [symbol] (X) [symbol] is the mapping defined such that
\tilde{λ}(x)εA for each xεX,
2° if t is as in the DN-definition, then
   \tilde{λ}(t)=∪(\tilde{λ}w(sⱼ,nⱼ))(kⱼ←e(j, [symbol] (i←e( k̅ᵢ,\tilde{λ}(w(sᵢ,nᵢ))):i ε [symbol] ∩Uno(inp(L(r))))):
      jε [symbol] ∩Uno(outp(L(r)))):rελ(σ)).
      [1.3.03] Let [symbol] and [symbol] be two Σ-algebras, A being the set of the elements of [symbol] and B being the set of the elements of [symbol] . Because [symbol] (X) is a free algebra, we can choose such two monadic mappings f and g and morphism f̅ and g̅ that
f(σ)=g(σ)=σ for each σεΣ
and \tilde{f}(F_{Σ}(X))=A and \tilde{g}(F₉₃ (X))=B.

Thus homomorphism h: [symbol] is such a mapping that for each denumerable ΣX-net t
h(\tilde{f}(t))=\tilde{g}(t).
   If α:A [symbol] B is such a mapping that a(\tilde{f}(x))=\tilde{g}(x) for each xεX, we say that h is an extension of α to a homomorphism: [symbol] symbolized by \hat{α}. Homomorphism \hat{α} is a denumerable substitution, if furthermore \tilde{f}(x)=x, whenever xεX. Later when rewriting DN:es we deal with the substitution defined in [symbol] (X). Let k:x [symbol] (i,s) be a mapping where xεX, s is a GN and iεΨ(L(s)). Thus mapping \hat{k}in the set of the nets is generalized net substitution (shortly substitution, if there is no danger of confusion), if for each net t
\hat{k}(t)=t(x←k(x): xεfron(t)).
   Notice that the denumerable substitutions in [symbol] (X) can be seen as special cases of generalized net substitutions.
   [1.3.04] Let P and T be arbitrary jungles. If S is a catenation of substitutions such that T=S(P), we say that there is a S-substitution route between P and T.
   [1.3.05] Net u is a context of net t, if t=u(i←(kᵢ,sᵢ): kᵢεΨ(L(sᵢ)), sᵢεS, iεΨT(L(u))) for jungle S of subnets of t; u can also be expressed with notation con_{P}(t), where P is the set of the positions of the substitutes of S in t. Notation con(T) means the set of all contexts of jungle T. We also call u the abover of nets sᵢ in t, denoted t\_{b}sᵢ, and each sᵢ is a belower of u in t, denoted t\ₐu.

If s is a subnet of net t, we say that t can be devided in two nets: s and the abover of s in t.

[1.3.06] Net t is an instance of net s, if t=f(s) for some substitution f. Context con_{P}(t) is the apex of s by f in regard to t, if P is the set of positions where substitution f takes places in s. See FIG. 1.3.06, where x₁, x₂, y₁ and y₂ are frontier letters and so is an apex of s (in regard to s).
FIG. 1.3.06 clarifies an apex of a net.
[1.3.07] Contexts of subnets in t are enclosements of t. Net s whose apex by substitution f is an enclosement of t is said to match t by f in the positions of g(s) in t. If net s matches net t, we say that the arities in set OS(s)\OS(t) are the matching arities of s in t.

Notice that even if a net itself is unbroken, an enclosement of it may be broken. See FIG. 1.3.07.

FIG. 1.3.07 is a figure of a broken enclosement of an unbroken net.

Graph u is an enclosement of graph v, if v=u(i←(kᵢ,sᵢ): kᵢεΨ(L(sᵢ)), sᵢεS, iεΨ(L(u))) for jungle S.

The set of all enclosements of the nets in jungle T is denoted enc(T).

Notice that the positions of an enclosement of a net are the positions of the tops of the enclosement in that net. For jungle T and S we denote p(T,S)=∪(p(t,s): tεT, s ε S∩enc(T)). Notice that nets s and t are the same, iff enc(s)=enc(t).

[1.3.08] The overlapping of nets is the maximal element in the intersection of the sets of the enclosements of those nets. If the overlapping is not empty, the nets overlap each other. We denote the overlapping of jungle S with notation [symbol] S, and the overlapping of nets sand t with s [symbol] t. Furthermore for any jungle S and T we denote S [symbol] T={s [symbol] t: tεT, SεS}. The omission of two nets s and t, denoted s [symbol] t, is the union (s\_{b} (s [symbol] t))∪(s\ₐ (s [symbol] t)); notice that one of the two sets to be united is always empty, which one depends on weather s [symbol] t is the abover or the belower of s. For arbitrary net s and jungle S we denote s [symbol] T=∩(s [symbol] t:tεT) and for jungles S and T we use notation S−T={s [symbol] T:SεS}. For an arbitrary nets s and t the positions of the outside arities of t in s, (OS(t,s)), means the set of the positions of all those arities of the elements in L(t [symbol] s) which are not occupied by anything in net s.
[1.3.09] For jungle T a type ρ of net (e.g. a tree) being in enc(T) is a maximal ρ-type net in enc(T), if it is not an enclosement of any other p-type net in enc(T) than itself. The other p-type nets in enc(T) are genuine.
[1.3.10] A set of nets is said to be a cover of net t, if each node of t is in a net of the set. See FIG. 1.3.10. We denote the set of all covers of net t with Cov(t).
FIG. 1.3.10 describes a cover of a net.
[1.3.11] Cover A saturates net t, if A⊂enc(t). We denote the set of all saturating covers of net t with Sat(t). See FIG. 1.3.11.1.
FIG. 1.3.11.1 is a figure of a saturating cover.
E.g. a saturating cover of net t is natural, if each net in the cover is maximal tree of t. See FIG. 1.3.11.2.
FIG. 1.3.11.2 is an example of a natural cover.
[1.3.12] A saturating cover of net t is a partition of t, if each node of t is exactly in one net in the cover. We reserve notation Par(t) as for the set of all partitions of net t For an arbitrary jungle A we define the partition induced by jungle A (denoted PI(A))={( [symbol] A′ [symbol] { [symbol] A″:A′⊂A″, A″εP(A)}:A′εP(A)}. We can write the following clause:
[1.3.13] Clause. “A correlation between partitions and covers of nets”.

### For any net s

EεCOV(s), if and only if PI(E) [symbol] sεPar(s).

Notice that if A is a saturating cover of net t, then PI(A) is a partition of t. See FIG. 1.3.12.
FIG. 1.3.12 describes a partition of a net.

### 1.4. Rewrite

[1.4.1] A rewrite rule is a set (possibly conditional) of ordered ‘net-jungle’-pairs (s,T) denoted often by s→T (which can be seen as nets if we keep “→” as a ranked letter); s is called the left side of pair (s,T) and T is the right side of it. We agree that right(R) is the set of all right sides of pairs in each element of set R of rewrite rules; left(R) is defined accordingly to right(R). The frontier letters of nets in those pairs are called manoeuvre letters).

A rule is said to be simultaneous, if it is not a singleton. The inverse rule of rule φ, φ⁻¹, is the set {(t,s):tεT, (s,T)εφ}. A rule is single, if it is singleton and the right side of its pair is also singleton.

[1.4.2] A rule is an identity rule, if the left side is the same as the right side in each pair of the rule. A rule is called monadic if there is a monadic mapping connecting the left side to the right side in each pair of the rule. If for each pair r in rule φ, hg(left(r))>hg(right(r)), we call φ height diminishing, and if hg(left(r)<hg(right(r)), φ is height increasing, if hg(left(r))=hg(right(r)), we call φ height saving.
[1.4.3] A rule is alphabetically diminishing if for each pair r in the rule there is in force: (i) right(r) is a frontier or ranked letter or (ii) hg(left(r))=2, top(right(r)) ε L(left(r)) and right(r) is a minimal rewritten net, meaning that its genuine subnets are all in a manoeuvre alphabet.
[1.4.4] Any rule and the concerning pairs in it are said to be
1° manoeuvre increasing if for each of its pairs, r, fron(left(r))⊂fron(right(r)), and
2° manoeuvre deleting if for each of its pairs, r, fron(left(r))⊃fron(right(r)), and
3° manoeuvre saving if for each of its pairs, r, fron(left(r))=fron(right(r)), and
4° maneuver mightiness saving, if for each of its pairs, r,
   |p(left(r),x)|=|p(right(r),x)|, whenever x is a manoeuvre letter, and
   5° maneuver mightiness decreasing, if for each of its pairs, r,
   |{p(left(r),x): x is a manoeuvre letter}|⊃|{p(right(r),x): x is a manoeuvre letter}|, and
   6° arity increasing if for each of its pairs, r, OS(left(r))⊂OS(right(r)), and
   7° arity deleting if for each of its pairs, r, OS(left(r))⊃OS(right(r)), and
   8° arity saving if for each of its pairs, r, OS(left(r))=OS(right(r)), and
   9° arity mightiness saving, if for each of its pairs, r,
   |p(left(r),ξ)|=|p(right(r),ξ)|, whenever ξ is an unoccupied arity letter, and
   10° letter increasing if for each of its pairs, r, L(apex(left(r)))⊂L(apex(right(r))), and
   11° letter deleting if for each of its pairs, r, L(apex(left(r)))⊃L(apex(right(r))), and
   12° letter saving if for each of its pairs, r, L(apex(left(r)))=L(apex(right(r))), and
   13° letter mightiness increasing if for at least one of its pairs, r,
   |∪(p(apex(left(r)),z): z is a frontier or ranked letter)|<|∪(p(apex(right(r)),z): z is a frontier or ranked letter)|.
   [1.4.5] Rule φ is left linear, if for each r ε φ and manoeuvre letter x there is in force |p(left(r),x)|=1, and right linear, if |p(right(r),x)|=1. A rule is totally linear, if it is both left and right linear.
   [1.4.6] A set consisting of rewrite rules and of conditional demands (possibly none) (for the set of which reserved symbol [symbol] ) to apply those rules (e.g. concerning application orders or the objects to be applied (desired substitutions or the positions where applications are wanted to be seen to happen)) is called a renetting system RNS, and a Σ-RNS, if its rewrite rules consist exclusively of pairs of ΣX-nets. Notice that rules in RNS:es can be presented also barely type wise: nets in pairs of rules in RNS:es are allowed to be defined exclusively in accordance with the amount of the arities or nodes possessed by them.
   [1.4.7] A RNS is finite, if the number of rules and [symbol] in it is finite. A RNS is said to be limited, if each rule of it is finite and in each pair of each rule the right side is finite and the heights of both sides are finite. For the clarification we may use notation [symbol] instead of [symbol] for RNS [symbol] A RNS is conditional (or sensitive), contradicted nonconditional or free, if its [symbol] is not empty. A RNS is simultaneous, contradicted nonsimultaneous, if it has a simultaneous rule.
   [1.4.8] A RNS is elementary, if for each pair r in each rule of the RNS is monadic or alphabetically diminishing. If each of the rules in a RNS is of the same type, the RNS is said to be the type, too. For each RNS [symbol] we denote [symbol] = [symbol] (φ−φ⁻¹).

### 1.5. Application and Transducers

[1.5.01] For given RNS [symbol] , jungle S is [symbol] -rewritten to jungle T, and is reduced under [symbol] or by rule φ of [symbol] , and is said to be a rewrite object for [symbol] or so, denoted
S→ [symbol] T (called [symbol] -application) or T=Sφ,
   if the following “rewrite” is fulfilled:
   T=∪(S(p [symbol] \tilde{f}(right(r))): left(r) matches s in p by some substitutions f and \tilde{f}, rεφ, sεS, pεp(S), [symbol] )), where \tilde{f} is specified in [symbol] and if it is not specified we suppose \tilde{f}=f. Notice that T=S, if any left side in any pair in p does not match any net in S. We say that S is a root of T in [symbol] and T is a result of S in [symbol] . See FIG. 1.5.01, where h, an enclosement of s, is the apex of k, and x₁, x₂, x₃ are frontier letters.
   FIG. 1.5.01 describes an enclosement of a net, where rewrite takes a place in that net.
   [1.5.02] The enclosements at which rewrites can take places (the sets of the apexes of the left sides in the pairs of the rules in RNS:es) are called the redexes of the conserning rules or RNS:es in the rewritten objects. For RNS [symbol] and jungle S we denote

S [symbol] =∪(Sφ:φε [symbol] ).

Rule φ of [symbol] is said to be applied to jungle S, if for each sεS s has φ-redexes (redexes of φ in s) fulfilling [symbol] and thus φ is applicable to S and S is φ-applicable or φ-rewritable. RNS [symbol] is applicable to S and S is [symbol] -applicable or [symbol] -rewritable, if [symbol] contains a rule applicable to jungle S.
FIG. 1.5.02.1 illustrates an example of an application of manoeuvre mightiness increasing rule and on the other hand an example of an application of manoeuvre letter increasing conditional rule. In the figures a, b, α, and β are nets and x, y and z are frontier letters.
[1.5.03] Lemma 1.5.1. Any relation can be presented with a RNS and its rewrite objects. On the other hand with any given RNS and jungle we are able to construct a relation.
Proof. Let r be a relation. Constructing RNS [symbol] ={a→b: (a,b)εr} we obtain
r={(a,a(a→b)):a→b ε [symbol] }.
   On the other hand for any RNS [symbol] and jungle S
{(s,sφ):sεS, φε [symbol] }
   is a relation. □
   [1.5.04] Derivation [symbol] in set [symbol] of RNS.es is any catenation of applications of RNS:es in [symbol] such that the result of the former part is the object of the latter part of the consecutive elements in the catenation, and the results in the elements in the catenation are called [symbol] -derivatives of the object in the first element, and the catenation of the corresponding rules is entitled deriving sequence in [symbol] , for which we use the postfix notation. We agree that for any deriving sequence [symbol] and any jungle S
[symbol] =(S [symbol] , if [symbol] = [symbol] .
   [1.5.05] Let A be a jungle, t a net in A, Ξ a set of frontier and ranked letters, [symbol] =(Ā,Ξ,f) a—Ξ-algebra, [symbol] , a set of conditional demands and for each ranked letter ξεΞ realization anchoring relation f(ξ) is defined as follows:
f(ξ):ξ(i→aᵢ: iεinpξ, aᵢεA) [symbol] ({aᵢ: iεinpξ,aᵢεA}(ξ))^{outrankξ},
   where k, an attaching mapping, is a mapping joining each ξ to a set of RNS:es. Thus [symbol] -realization of net t, ( [symbol] ), is a t-transducer (TD) over set ∪k(Ξ) of RNS:es, and an interaction between those RNS:es.

C [symbol] , can e.g. be the following:
For some φεenc(t) ã [symbol] =ã, whenever ãε [symbol] where [symbol] [symbol] =Uno(Ψ(L((φ))), if for subnet φ′ of φ (top((φ′) [symbol] does not match ã [symbol] for some νε fronnet(φ′). That demand means that the realizations of each node in some enclosement of t has to match the substitutes in the replacements of the inputs in each node in [symbol] -operation of that enclosement, if [symbol] is to be applicated.
   For the clarification we may use notation C [symbol] instead of C [symbol] for TD

[symbol]

Notice, that RNS:es are special cases of transducers as well as semantic networks and symbol compinations and clauses of predicate, mathematical or formal logic represented as RNS:es (lemma 1.5.1) are examples of widely occurring type of elementary TD:es.

Let [symbol] be an arbitrary set, and for each iε [symbol] let [symbol] be a TD, thus we denote [symbol] =Π({ [symbol] }:iε [symbol] ), and ā [symbol] =Π(e(i,ā) [symbol] iε [symbol] ), whenever ā is a Cartesian element. For any applicant S S [symbol] is called the result of S in [symbol] .

[1.5.06] Lemma 1.5.2. The conditional demands can be presented as a TD having no demands, and thus any TD, let us say [symbol] , can be given as a TD with no demands and the carrying net having the carrying net of [symbol] in its enclosements.
Proof. The claim is following from lemmas 1.2.1 and 1.5.1. □
[1.5.07] If each RNS in a TD is of the same type (e.g. manoeuvre saving), we say that the TD is of the type. A TD is said to be altering, if while applying it is changing, e.g. the number of the rules in its RNS:es is changing (thus being rule number altering. A TD is entitled contents expanding, if some of its RNS:es contain a letter mightiness increasing rule. A TD is called trivial, if each applicant is the same as the result in the TD.
[1.5.08] A TD is a transducer graph (TDG) over a set of transducers, if the set of the carrying nets of all transducers in the set is a partition of the carrying net of the TD. The transducer graph over set T is denoted TDG(T), and any TDG(T) is said to be beyond each subset of T, denoted in the same way as for TG concerning that subject.

A TDG is entitled direct (in contradiction to indirect in other cases), if the only demands for the TDG are those of the TD:es in the TDG.

Any TDG over a set can be visualized as a TG over the same set.

[1.5.09] Lemma 1.5.3. The carrying net of any altering TD can be seen as an enclosement of the larger carrying net of some nonaltering TD.
Proof. Straightforwardly from lemma 1.5.2 □
[1.5.10] For TD [symbol] we define relation → [symbol] (called [symbol] transformator) in G(Σ,X)^{≦inp(X)} such that
→ [symbol] ={(ā, [symbol] x←[inp(X)](i,ā):iεinp(x), xεX)): āεG(Σ,X)^{≦inp(X)}}.
   [1.5.11] For any transducers [symbol] and [symbol] we define [symbol] = [symbol] if → [symbol] =→ [symbol] is, is the notation for the set of all derivations in [symbol] is applicable to jungle S and S is [symbol] -applicable, if [symbol] is φ-rewritable, whenever [symbol] φ is a deriving sequence in [symbol] If a jungle is not [symbol] applicable, it is entitled [symbol] -irreducible or in normal form under [symbol] . For the set of all [symbol] -irreducible nets we reserve the notation IRR [symbol] . For each jungle S and TD [symbol] we denote the following:

[symbol] *|S is the set of the elements in [symbol] * applicable to S,

S [symbol] =S{→ [symbol] }*∪IRR

[symbol]

[symbol]

|S={r:rε [symbol] *|S, Sr ⊂̅S [symbol] )}.

### 1.6. Equations and Decompositions

[1.6.1] Let [symbol] and [symbol] be two TD:es. Let H be a list of symbols in [symbol] and [symbol] where [symbol] ={=,ε,⊂, ⊂̅}. If (→ [symbol] ) [symbol] (→ [symbol] ) for some substitutes of H, we call [symbol] (H) a RNS-equation (RE) and those substitutes are its solutions.

RNS-equations cover also the ‘ordinary’ equations (with no RNS:es), being due to lemma 1.5.1, because we can chose such TD:es to represent equations that the carrying nets of those TD:es contain frontier letters, and RNS:es in the TD:es have rules the right sides of which contain the same realizations of the same carrying net as in the ordinary equations.

[1.6.2] Subset P of enc( [symbol] ) is called a factor in RNS-equation [symbol] (H); a left handed factor, if P ⊂̅enc [symbol] ), and a right handed factor, if P ⊂̅enc( [symbol] ) . [symbol] (H) is of first order in respect to an element of H, if the element exists only once in the equation.
[1.6.3] Let K be a factor in RNS-equation [symbol] (H). We say that the RE is a representation of K; specifically an elicit one (in contradiction to implicit in other cases), if K= [symbol] and K⊂enc( [symbol] ). The right handed factors are decomposers of K and [symbol] is a decomposition for K, if [symbol] (H) is an explicit representation of K and [symbol] is =. A decomposition of K is said to be linear/unlinear, if it is a direct/an indirect TDG.

### § 2. Inventiveness

[2.1] Recognizers and languages
[2.1.1] Let A and B be sets and let α: A [symbol] B be a binary relation. Let A′ be a subset of B. We define recognizer [symbol] such that [symbol] =(α,A′). Jungle S (probed object) is said to be recognized by recognizer [symbol] , if SαεA′. E.g. “validity of inference”: RNS-equations for combinations of elementary logical relations being probed objects a is “true value surjection morphism” from {g:g is a TFG of h, hεTG} to true values, A′ representing value “true”. Language [symbol] is the set of the elements recognized by [symbol] . Notice that, if α is the identity mapping in the set of elements, there is a valid equation A′= [symbol] meaning that recognizer (α,A′) separates from arbitrary set of elements those ones, which have property A′. Observe also that a can be a TD-transformator providing very wide variety of use.
[2.1.2] Let [symbol] be an arbitrary set and for each i,jε [symbol] let Aᵢ be a set and θᵢⱼ: Aᵢ [symbol] Aⱼ a binary relation. Let Ā( [symbol] )=Π(Aᵢ: iε [symbol] ) and \tilde{θ}=∇(θᵢⱼ: (i,j)ε [symbol] ) for some [symbol] . Let α:Ā( [symbol] ) [symbol] Π(θᵢⱼ: (ij)ε [symbol] ) be a binary relation, where āα=Π(θᵢⱼ: (i,j)ε [symbol] e(i,ā) θᵢⱼ e(j,ā)), whenever āεĀ( [symbol] ). The language recognized by [symbol] =(α,\tilde{θ}) is \tilde{θ}-associated over [symbol] (denoted [symbol] ); if in \tilde{θ} each θᵢⱼ=θ, we speak of θ-associated language.

Notice that θ-associated language over a singleton is θ-relation itself, if [symbol] =2. Furthermore it is noticeable that a set consisting of the projections in an element of θ-associated language is an equivalence class of θ-relation, if θ is an equivalence relation. Inversely to the above: a set of elements, the projections of the elements figure a θ-equivalence class, is θ-associated language.

[2.2] Problem and solution
[2.2.1] Problem [symbol] is a triple (S, [symbol] ), where the subject of the problem S is a jungle called the mother graph, [symbol] is a recognizer and limit demands [symbol] (denoted [symbol] as independent) is a sample of demands conserning solutions of the problem [symbol] . TD [symbol] is a presolution of problem [symbol] , if S [symbol] ε [symbol] thus S [symbol] being called a solution product, and if furthermore [symbol] fulfils the demands in set [symbol] , [symbol] is a solution of [symbol] E.g. solution [symbol] can be a system, by which from certain circumstances S, can be built with some limit demands (e.g. the number of the steps in the process) surrounding S [symbol] which in certain state α(S [symbol] ) (for morphism a) has a capacity of A′-type.
[2.2.2] We can describe a solution for a problem as wandering in a net:

1. The start from a given node (mother graph) of the TFG

2. to the right node (solution product) (ε [symbol] ) of the TFG

3. via the right route in the TDG (solution) (fulfils limit demands).

### § 3. Parallel Process and Abstract Algebras (for Automated Problem Solving)

### 3.1. Partition RNS and Abstraction Relation

[3.1.1] For each net (here c) we define a partition RNS (PRNS) (here [symbol] ) of that net as a RNS fulfilling conditions (i)-(iii):
(i) [symbol] is manoeuvre mightiness and arity mightiness saving
(ii) 1. {apex(left(φ)): φε [symbol] } is a partition of net c

or 2. [symbol] ⊃{L(c)∩L(c [symbol] )=Ø}

(iii) apex(right(φ)) is a letter outside set L(c) whenever φε [symbol] , and {(left(φ),right(φ)): φε [symbol] } is an injection.

We say that c [symbol] is [symbol] -partition result for c. Observe that for each PRNS there may be several nets, the PRNS:es of which that RNS is an example of. Those nets have apexes of left sides of rules in the RNS in different positions.

[3.1.2] Lemma 3.1. For each net c and each PRNS

[symbol]

c [symbol] ̂=c

Proof. Straightforward. □
[3.1.3] If for nets s and t and PRNS [symbol] there is an equation s [symbol] =t, we say that s is a substance of t in [symbol] , and t is a concept of s in [symbol] .
In the following presented “abstraction relation” is needed in process to refere to a common origin for partitions of subjects in problems to be solved and known ones.
[3.1.4] The abstraction relation (AR) is such a binary relation of the pairs of nets, where for each pair (here (s,t)) there is such net c and PRNS:es [symbol] and [symbol] , that
c [symbol] =s and c [symbol] =t.
   Nets s and t are said to be abstract sisters with each other.
   [3.1.5] Let θ be a relation in a set of nets, and let (s,t) be an element in that relation. If (sφ,tφ)εθ, whenever φ is a manoeuvre mightiness and arity mightiness saving renetting rule which has a redex in s and t, we say that s and t are θ-congruent with each other, and if the elements in each pair of θ are θ-congruent, we call θ a congruent relation. If a relation is both an equivalence and congruent relation, it is entitled a congruence relation.
   [3.1.6] The construction for a common substance of two nets given in the proof of the following characterization theorem 3.1 is the only possible one of those most wide range models.
   “A characterization of the abstraction relation”—Theorem 3.1. Let θ be the abstraction relation, and a and b be two nets. Thus
a θ b [symbol] |OS(a)|=|OS(b)|.

### Proof.

Let A₁∪A₂ be a partition of net a, and let B₁∪B₂∪B₃ be a partition of net b. The conserning partitions may exclusively consist of letters in net a and b. We can construate substance c for a and b as in the following figures, distinguished in two different cases.

For border [symbol] in the partition of net a and borders [symbol] and [symbol] in the partition of net b it is to be constructed net c and partitions for it, where
(i) A′-partition: A₁′∪A₂′, where |A₁′|≧|A₁|, |A₂′|≧|A₂|, and there is bijection fₐ: A₁′∪A₂′ [symbol] A₁∪A₂ such that |L(a′)|≧|L(fₐ(a′))| whenever a′εA₁′∪A₂′, and
(ii) B′-partition: B₁′∪B₂′∪B₃′, where |B₁′|≧|B₁ |, |B₂′|≧|B₂| and |B₃′|≧|B₃|, and there is bijection f_{b}: B₁′∪B₂′∪B₃′ [symbol] B₁∪B₂∪B₃ such that |L(b′)|≧|L(f_{b}(b′))| whenever b′εB₁′∪B₂′∪B₃′, and
(iii) border [symbol] “inside nets in B₂′ “and borders [symbol] and [symbol] ” inside nets in A′-partitions “fulfil the equations: | [symbol] |=| [symbol] , | [symbol] |=| [symbol] |,| [symbol] =| [symbol] |, and
(iv) Λ₁ and Λ₂ are sets of outside arities.

Straightforwardly we thus can construct PRNS:es [symbol] ₐ and [symbol] _{b} of net c such that A₁′ [symbol] =A₁,A₂′ [symbol] =A₂, B₁′ [symbol] =B₁, B₂′ [symbol] =B₂ and B₃′ [symbol] =B₃.

Case 1° The outside arities are in neighbouring elements in a partition of net b. See FIG. 3.1.6.1.
FIG. 3.1.6.1 is the description for the proof of “a characterization of the abstraction relation”-theorem 3.1 in the case where the outside arities in the other concept are in neighbouring elements of a partition.

Case 2° The outside arities are in such elements of a partition of net b which are totally isolated from each other. See FIG. 3.1.6.2.

FIG. 3.1.6.2 is the description for the proof of “a characterization of the abstraction relation”-theorem 3.1 in the case where the outside arities in the other concept are in elements of a partition totally isolated from each other.

### Proof. :

Let |OS(a)|≠|OS(b)|. If c is a substance for net a, we have |OS(c)|=|OS(a)|, because the PRNS between a and c is arity mightiness saving, and from the same reason we are not able to get any concept to c with the mightiness of the outside arities differing from the one of c. Therefore (a,b)∉θ.□
[3.1.7] Corollary 3.1. Any substance and any of its concepts are in the abstraction relation with each other.
Proof. Any substance and its concepts have the same amount of outside arities, because interacting PRNS:es are arity mightiness saving. □
[3.1.8] Corollary 3.2. The abstraction relation is a congruence relation.
Proof. Let a and b be two nets in the abstraction relation θ with each other. Let φ be a manoeuvre mightiness and arity mightiness saving rule which has a redex both in a and b. Theorem 3.1 yields |OS(a)|=|OS(b)|, and therefore θ is an equivalence relation. In accordance with the definition of our φ we have |OS(aφ)|=|OS(bφ)|, and therefore we obtain aφθbφ from theorem 3.1 yielding θ is congruent. □
[3.1.9] Any class of the abstraction relation is formed by transformation graphs outdominated (‘centered’) by substances (FIG. 3.1.9.2): incomplite images of ‘minimal’ realization process graphs of a TG over a set of TD:es (FIG. 3.1.9.1 ) in the class. In the figures c₁, c₂ and c₃ are substances and [symbol] and [symbol] are TD:es.
FIG. 3.1.9.2 describes forming a class of the abstraction relation by transformation graphs outdominated (‘centered’) by substances.
FIG. 3.1.9.1 describes incomplite images of ‘minimal’ realization process graphs of a TG over a set of TD:es in the class of the abstraction relation.

### 3.2. Altering RNS

“Macros” treated in this chapter are needed in process to get solutions for elements in the subject of the problem in study via known solutions in memories for problems with e.g. another elements in the subjects.

[3.2.1] “Altering macro RNS”-theorem 3.2.1. For each PRNS [symbol] and each RNS [symbol] there is RNS [symbol] and PRNS [symbol] such that there is in force an implicit equation of first order for unknown [symbol] , where [symbol] is a decomposer of a linear decomposition for [symbol] : [symbol] = [symbol]
Proof. Let \tilde{d} symbolies the apex off d whenever d is a net.
1° Let [symbol] be a PRNS.
2° Let [symbol] an arbitrary RNS and let set { [symbol] (φ):φε [symbol] : be a family of distinct sets, and for each rule φ in [symbol]
   (i) φ={aᵢ→Bᵢ: iε [symbol] (φ)}, and
   (ii) Let [symbol] be such a subset of [symbol] (φ) that D∩E=Ø, where
      D=∪enc{apex(aᵢ):iε [symbol] }, and
      E=∪enc{apex(b): bεBᵢ, iε [symbol] (φ)}∪enc{apex(left(r)): rεφ,apex(left(r))∉apex(L(right( [symbol] ))( [symbol] )̂)}, and
   (iii) Let [symbol] φ)= [symbol] (φ)\ [symbol] . For each (k,j)ε [symbol] (φ)× [symbol] (φ) and each bₖεBₖ let \tilde{s}_{bkj} be the maximal nonempty element of intersection enc(apex(aⱼ))∩enc(apex(bₖ)), and the apex of net s_{bkj}. Furthermore let bₖ′ and aⱼ′ be such nets that s_{bkj} is the abover of bₖ′in bₖ and the abover of aⱼ′ in aⱼ.
      3° Let us now construct required [symbol] a rule number altering macro RNS for [symbol] in regard to [symbol] , (thus [symbol] being one of its micro RNS.es). For each iε [symbol] (φ) and each φε [symbol] let [symbol] be a set of such nets that there exists PRNS [symbol] for which bᵢ→fᵢ(bᵢ)ε= [symbol] for bisection fᵢ: Bᵢ→ [symbol] , whenever bᵢεBᵢ (notice that [symbol] is straightforwardly to be constructed).

Furthermore let g be a bisection with left(∪( [symbol] ) as its domain set such that g(a)εa [symbol] ̂, whenever ã ε apex(L(right( [symbol] ))( [symbol] )̂∩apex(left(∪ [symbol] ))).

Let σ_{bkj} be such a net that its apex is a letter (∉L( [symbol] ∪ [symbol] )) for which |OS(\tilde{σ}_{bkj})|=|OS(\tilde{s}_{bkj})|, and in addition let nets βₖ′, θₖ and αⱼ′ be such that σ_{bkj} is the abover of βₖ′in ηₖ and αⱼ′ in g(aᵢ), where |OS(\tilde{β}ₖ′)|=|OS(\tilde{b}ₖ′)|, |OS(āⱼ′)|=|OS(āⱼ′)|, and for each manoeuvre letter x

|p((ηₖ),x)|=|p((fₖ(bₖ)),x)| and |p(g(aⱼ),x)|=|p(aⱼ,x)|.

In addition let [symbol] = [symbol] ((aᵢ←g(aᵢ)),(bᵢ←fᵢ(bᵢ)): iε [symbol] (φ), bᵢεBᵢ, φε [symbol] ) be the set of conditional demands for our macro.

Now [symbol] ={g(aⁱ)→ [symbol] , fₖ(bₖ)→ηₖ: iε [symbol] (φ), kε [symbol] (φ)), bₖεBₖ, φε [symbol] }, because thus there can be constructed an interacting PRNS between each simultaneous phase of processes [symbol] and [symbol] ; (even in the case where applicants for [symbol] and [symbol] are not unbroken and [symbol] is manoeuvre deleting). □

See FIG. 3.2.1, where βₖ=fₖ(bₖ) and βⱼ=fⱼ(bⱼ), and αₖ=g(aₖ) and αⱼ=g(aⱼ), R is a rewrite object.
FIG. 3.2.1 describes constructing macro RNS.
[3.2.2] The phase P in the process in the proof of the above theorem 3.2.1 enable macros to depend only on their micros and the PRNS:es, but not on the rewrite objects which might contain large number or even unlimited number of places for redexis of rules in micros. Furthermore it is considerable that rules in [symbol] can be spared to be constructed untill it is necessary in processes applying [symbol] . It is also noticable that \tilde{β}ₖ′ and ãⱼ′ can be picked among letters or on the other hand e.g. \tilde{β}k′ can be chosen to be bₖ′ and α̅ⱼ′can be aₙ′.

### 3.3. Parallel Process and the Closure of Abstract Languages

[3.3.1] Let [symbol] be an arbitrary set and for each i,j ε [symbol] let θᵢⱼ be the abstraction relation, and let \tilde{θ}=Π(θᵢⱼ: (i,j)ε [symbol] for some [symbol] ⊂ [symbol] , thus \tilde{θ}-associated languages is called [symbol] -abstract language
[3.3.2] Let [symbol] be a set of RNS:es and [symbol] TD over a [symbol] We define a macro TD of [symbol] in regard to [symbol] denoted [symbol] for which [symbol] = [symbol] ← [symbol] ), where [symbol] is a macro RNS for [symbol] in regard to [symbol] We say that [symbol] is a micro TD of [symbol] and denote it [symbol] .
[3.3.3] Following “parallel”-theorem describes the invariability of the abstraction relation or the closures of abstract languages, and taking advantage of the equation of “altering macro RNS”-theorem it gives TD-solutions for any problem whose mother graph is an abstract sister to a graph which is the mother graph of a problem TD-solutions of which are known.
[3.3.4] “Parallel”-theorem 3.3.1. Let [symbol] be a TD, θ the abstraction relation, a and b two nets, [symbol] and [symbol] two PRNS:es of c, a being a concept of c in [symbol] and b a concept of c in [symbol] . If aθb, then
1° a [symbol] θ b [symbol] , that is
θ is closed under transformator ( [symbol] ), in other expression θ( [symbol] ) ) ⊂̅θ, and
2° a [symbol] θ b [symbol] , that is
θ is closed under transformator [symbol] ), in other expression θ( [symbol] )⊂θ.
Proof. The claims of the theorem follow from “altering macro RNS”-theorem, because [symbol] = [symbol] , and rules of RNS:es in macro TD:es can be spared to be constructed untill it is necessary in processes applying micro RNS:es. □
We call [symbol] and [symbol] parallel with each other, and consequently on the other hand [symbol] and [symbol] are also parallel with each other. See FIG. 3.3.4.
FIG. 3.3.4 describes the relation between parallel TD:es.

### 3.4. Abstract Algebras

[3.4.1] Lemma 3.4.1. All nets in any denumerable class of the abstraction relation have the shared substance (the center of that class).
Proof. Let θ be the abstraction relation and let H be a denumerable θ-class. Each substance and its concepts are in the same θ-class in according to corollary 3.1. Because H is an equivalence class being due to corollary 3.2, all substances in H are in θ-relation with each other. Repeating the reasoning above for substances of substances and presuming that H is denumerable we will finally obtain the claim of the lemma. □
See FIG. 3.4.1 for center c of a denumerable θ-class: a tree, where the node with no outputs is the center.
FIG. 3.4.1 is figuring the tree formation of a denumerable class of the abstraction relation.
[3.4.2] Lemma 3.4.2. Let θ be the abstraction relation restricted to the set of all distinct nets (thus we say θ is distinctive). Furthermore let [symbol] not be a contents expanding TD, and let Q be a denumerable θ-class with c being its center. In addition we denote
[symbol] =={ [symbol] is a PRNS of c} ∪

[symbol]

### Therefore

Q [symbol] =(c [symbol] )θ.
   Proof. Because θ is an equivalence relation and θ is distinctive, parallel theorem 3.3.1 yields Q [symbol] ⊂(c [symbol] )θ. On the other hand, being due to our presumption for [symbol] we obtain (c [symbol] )θ⊂Q [symbol] following from the construction for macros in the proof of the “altering macro RNS”-theorem and because [symbol] is not increasing the number of partitions while applying it. □
   [3.4.3] It is noticable that the restriction for θ in lemma 3.4.2 is merely of formal nature and contain any really restriction in practice, because each jungle is anytime possible to bound to a jungle of distinct nets by a suitable bijection.
   [3.4.4] “Abstraction closure”-Theorem 3.4.1.

If there are in force following presumptions (i)-(iv):
(i) θ is the distinctive abstraction relation,
(ii) A is the set of the denumerable θ-classes,
(iii) [symbol] is a TD, but not contents expanding and
(iv) [symbol] is as in lemma 3.4.2, and we denote [symbol] ={ [symbol] : c is the center of a θ-class},

then

A. pair (A, [symbol] ) is an algebra.

If in addition to presumptions (i)-(iv) there is one more presumption (v):
[symbol] ={ [symbol] cεM}, where M is the set of the centers of set H of denumerable θ-classes, then
   B. pair ((M [symbol] )θ, [symbol] ) is an algebra (so called abstract algebra) with H as its generator set.
   A-Proof. Lemma 3.4.2 yields claim A.
   B-Proof. As a consequence of Parallel theorem 3.3.1 and lemma 3.4.2 any element in set [symbol] is a center, whenever c is a center. □
   [3.4.5] The above “abstraction closure”-theorem can be figured as follows: As far as contents in processes are not being expanded ( [symbol] is not contents expanding), each abstraction (element in (M [symbol] )θ) for the products (εM [symbol] ) can be verified, if and only if we know each abstraction (element in H) for the elements (εM) to be processed.

### § 4. General Framework for Partition and Abstraction Relation

[4.1] Let φ be a relation in the set of the nets, and let [symbol] be a TD. Let then a and be two nets in φ-relation with each other. In order to set up the general framework for partitions and the abstraction relation the first question is: what kind of TD [symbol] is, if the products a [symbol] and b [symbol] are supposed to be in φ-relation with each other? See FIG. 4.1.
FIG. 4.1 is clarifying the nature of the invariability of a relation in processing a pair of TD:es.
[4.2] The next step is to consider a relation between φ and apexes of the left sides of pairs in rules of RNS:es in [symbol] We can imagine the case, where r is such an element in a rule of a RNS in [symbol] that apex(left(r))∩enc(a)=Ø, but apex(left(r)) is not in any partition of net a. The more general case is described in the figure below, where there is more than one that kind of net a. See FIG. 4.2, where \tilde{r} is the apex of r.
FIG. 4.2 is a complicated version of FIG. 4.1 with more than one element in the processed relation.
[4.3] We can imagine even more general case, where the relation θ to be studied, is defined in the set of the nets such that nets [symbol] and [symbol] are in θ-relation with each other, if there is such cover α for [symbol] and such cover β for [symbol] that θ consists of pairs where one part is in α and the other is in β, and these parts are in p-relation with each other. Those covers may consist of disjoined nets (thus θ is a ‘primitive’ ordinary relation and θ⊂φ) or intersected nets or they may form partitions, etc. See FIG. 4.3.1, where A⊂α and B⊂β.
FIG. 4.3.1 describes a situation of FIG. 4.1, where the relation is compiled by covers.

Notice that r→S may be deleting. However even in that case, if each net in cover α and on the other hand in cover β is unbroken, [symbol] is changed by r→S only in those nets in α which intersect [symbol] and apex(r), and the demand “ [symbol] (r→S) and [symbol] (p→Q) are in θ-relation with each other” are fulfilled, if A(r→S) and B(p→Q) are in θ-relation with each other.

The situation is more complicated, if in cover α and in cover β there are some broken nets, in which case nets totally isolated from redexes of r→S may be affected. See FIG. 4.3.2 of a cover of 3-successive net [symbol] .

FIG. 4.3.2 is a figure of a 3-successive net and an effect of rewriting in totally isolated elements of a cover.

Notice that differing from the case in “altering macro RNS”-theorem p→Q is depending not only on θ and r→S, but also on the product [symbol] (r→S) and not exclusively in the case ‘r→S is deleting’. However p depends only on relation φ and on the neighbouring nets of the redexes of r→S in cover α, if no pair in the rules of the RNS:es in [symbol] is deleting. In general, if C is presenting the set of such nets in cover a which are affected by r→S, it must be that apex(p)εCθ, and Cθ(p→Q) is in θ-relation with C(r→S). That kind of large demands for p→Q when widening remembrance hunting in memories raises up the question about choosing the type of right covers and interacting RNS:es. That question is widely dealed with, and solved in the manner of the most general character in the next chapter.

### § 5. Controlling the Remembrance Hunting by Choosing Types of Interacting RNS:es

[5.1] In the following we are searching the solutions built by certain type of parts (elements in covers), this requirement is embedded in limit demands. The apexes of the left sides of the rules in RNS:es in known TD may not be elements in any partition of the mother graph of the problem studied, but merely in some more general cover of the mother graph fitting to limit demands. Thus we must study general covers (GCRNS:es) for mother graphs allowing the depth dimension (the overlapping of apexes in interacting rules are not necessarily enclosements in the rules), multiplication and new connections (between nodes; manoeuvre increasing ability), too. The relations between PRNS and GCRNS are especially in focus. We construct generalized macro/micro (GMA/GMI) TD for GCRNS. Abstraction relation θ is then defined as before except PRNS is replaced with different variations of GCRNS.
[5.1.1] For each relation λ we define relation RNS of λ, RNS(λ), such that
RNS(λ)={s→T:sεD(λ), T=sλ}.

Notice that in general there is in force equation [RNS(λ)]⁻¹=RNS(λ⁻¹).

[5.1.2] Let s be a net. The relation ED of s, TD(s), is the TD over {RNS(λ): λ is a node in s}, such that the attaching mapping in the realization anchoring relation of the TD joins each node in s to the relation RNS of that particular node.
[5.1.3] [symbol] is a cover RNS (CRNS) of net s, if it fulfils conditions (i)-(iv):
(i) [symbol] is manoeuvre mightiness and arity mightiness saving,
(ii) there is such net s′ for which Se enc(s′) and
[symbol] ⊃{L(s′)∩L(s′ [symbol] )=└} (totally applicant ranked letters changing),
   (iii) ∪(L(right((ω))) and set L(s) are distinct with each other, whenever ωε [symbol] ,
   (iv) {(left(ω),right( )): ωε [symbol] } is an injection.
   The set of all CRNS:es of net s is denoted CRNS(s). Observe that PRNS:es are examples of CRNS:es. We say that s [symbol] is [symbol] -cover result for S.
   [5.1.4] It is useful to keep in mind that neglecting influence of limit demands, simultaneousness and finiteness, the generality order of the changing power of RNS:es (difference between left and right sides of rules) can be described as followes:
   A. no difference (=totally restricted)
   B. the mightiness of the positions of ranked letters
   C. ranked letters
   D. the mightiness of the arities
   E. the mightiness of the positions of manoeuvre letters
   F. manoeuvre letters.
   [5.1.5] GPRNS is RNS which is defined as PRNS but the condition “manoeuvre mightiness saving” is replaced with demand “not manoeuvre deleting”, and GCRNS is RNS which is defined as CRNS with the above replacement.
   CLAUSE 5.1. Let [symbol] be a CRNS or even GCRNS of net a. If the right sides of the pairs in each rule of [symbol] are distinct from each other (we say [symbol] is distinct from right sides) (we reserve the symbols C_{d}RNS and GC_{d}RNS, respectively), then for each net a
a [symbol] =a.
   If [symbol] is not distinct from right sides, then for each net a we have a ε a [symbol]
   Proof. (G)C_{d}RNS is not manoeuvre deleting and is totally applicant ranked letters changing. □
   Next we consentrate to make notions adequate for differences between PRNS and CRNS.
   [5.2] “Characterization Clause”. Let a and b be two distinct nets. Then
   |OS(a)|=|OS(b)| [symbol] there is such CRNS [symbol] that a [symbol] =b
   Proof. [symbol] : CRNS is arity mightiness and manoeuvre mightiness saving, and therefore in the applicants of CRNS the mightiness of the set of the outside links of the redexes is not changing in derivations.
   Proof. [symbol] : Choose [symbol] ={a→b}. □
   The next characterization [5.3.0] says that the necessary and sufficient condition in order to be the result of a PRNS for a net is that there is a partition of the net and the unequivocal correlation between the elements of the partition and the letters of the result regarding the mightiness of the positions of the outside arities.
   [5.3.0] “Characterization Clause”. Let a and b be nets. Then
(Π PεPar(a)) (∃ n ε{|OS(α,b)|: αεL°(b)}∪{|OS(t)|: tεP})
         |⊚(p(P,t): |OS(t)|=n, tεP)|≠ [symbol] ⊚(p(b,α):|OS(α,b)|=n, αεL°(b))|,
      if and only if
a [symbol] ≠b, whenever [symbol] is a PRNS.
   Proof. Each PRNS is manoeuvre mightiness and arity mightiness saving. □
   Clearly CRNS is a genuine generalization of PRNS, and we can obtain even more restricting claim:

### Clause 5.3.1

{ [symbol] is a nonconditional and not letter mightiness increasing CRNS} ⊃{ [symbol] is a PRNS)}.
Proof. Clause 5.3.0 (see FIG. 5.3.1). □
FIG. 5.3.1 illustrates PRNS as a special case of more general cover RNS. In the figure b=a [symbol] , where [symbol] ={φ₁,φ₂}.
Clauses 5.3.0 and 5.3.1 raise the questions:
1° Overall, for what kind of pair (a,b) we succeed in finding such GPRNS or GCRNS, [symbol] that a [symbol] =b? For PRNS and CRNS we already have characterization clauses 5.2. and 5.3.0.
2° For which net a and CRNS [symbol] of a there is such PRNS [symbol] of a that a [symbol] =a [symbol] ? A suitable PRNS-candidate is constructed in the following clause 5.3.1.1.
[5.3.1.1] Clause. 5.3.1.1. Let [symbol] be a left-right distinct CRNS (that is: for each rules r of ω apex(left(r)) and apex(right(r)) are distinct from each other, whenever ωε [symbol] ), and for each rεω and each ωε [symbol] let
(∃ PεPar(left(r))) (∀n ε{|OS(α,right(r))|: α ε L(apex(right(r)))}∪{|OS(t)|: tεP})
   |⊚(p(P,t): |OS(t)|=n, tεP)|=|∪(p(right(r),α): |OS(α,right(r))|=n, α ε L(apex(right(r)))|.
   Hence there is such PRNS [symbol] that [symbol] = [symbol] .
   Proof. Being due to our presumptions for the rules of [symbol] clause 5.3.0 yields that (∀rεω)(∀ωε [symbol] )(∃ PRNS [symbol] ) apex(right(r)) is [symbol] -partition result for apex(left(r)). By choosing [symbol] =U( [symbol] :rεω,ωε [symbol] ={ [symbol] =∪( [symbol] ̂: rεω,ωε [symbol] ),{ [symbol] :rεω,ωε [symbol] }}) we'll get a desired PRNS, because [symbol] is left-right distinct. □
   [5.3.2] Notice that there is not always CRNS [symbol] of net a, such that a [symbol] =c(a) [symbol] , whatever PRNS [symbol] might be. E.g. c(a)εCov(a)\Par(a), hence |OS(c(a) [symbol] )|≠|OS(a)|, whenever [symbol] is PRNS. See characterization clause [5.2].
   FIG. 5.3.2 is figuring differences between cover orders and partition RNS:es. In the figure c(a)={d,f}, [symbol] ={α→γ, β→δ,d→e} and c(a) [symbol] ⊃{e,g}.
   Next in the following paragraphs we define cover reversely labelling RNS:es yielding the definition of generalized macros. Furthermore we prove “Altering Macro RNS”-theorem [3.2.1] to be generalized to deal also with wider interacting RNS-type, GC_{d}RNS, and in order to extend problem solving to fit also to that interacting type, characterization of abstraction relation regarding the type is introduced.
   [5.4.0] Let [symbol] be a RNS of type T, Tε{C_{d}RNS,GC_{d}RNS}, and let rₒ→R be a pair in a rule of a RNS. We denote
a=∩(apex(t) [symbol] ̂: apex(rₒ)εenc(apex(t) [symbol] ̂), t is a net).
   For rₒ let us define [symbol] , a single partition relation (over [symbol] ), such an injection in the set of the graphs that the sets of the apexes of the elements in its image sets are alphabets outside L(a) and any catenation of [symbol] is [symbol] itself, and the image of the relation RNS of [symbol] is manoeuvre mightiness and arity mightiness saving.

For each ωε [symbol] we define such set P_{ω}(rₒ,f_{ωr}_{ₒ}, {fᵣ_{ₒ}ᵣ: rεω}) of rules that

{left(r): rεφᵣ, φᵣ ε P_{ω}(rₒ, f_{ωr}_{ₒ}{fᵣ_{ₒ}ᵣ: rεω})}={left(p){ν→f_{ωr}_{ₒ}(ν):apex(ν)εPI(N), N⊂apex(left(p)) [symbol] ({apex(right(s)):sεω}∪{apex)rₒ){), ν matches left(p){:pεω}, and for each r(=r(r)) in each φᵣ (being an image set for r) εP_{ω}(rₒ, [symbol] , {fᵣ_{ₒ}ᵣ: rεω}) right(r)=left(r){ν→fᵣ_{ₒ}ᵣ(ν):apex(ν)ε{apex( [symbol] (μ)): μ is a graph}∪(apex(left(r))={apex [symbol] (μ)):μis a graph{), ν matches left(r)}, where for each r εω, fᵣ_{ₒ}ᵣ, a generalized partition relation (over [symbol] ), is such an injection in the set of the graphs that the sets of the apexes of the elements in its image sets are the same alphabets as is the matter concerning [symbol] , and any catenation of fᵣ_{ₒ}ᵣ is fᵣ_{ₒ}ᵣ itself, and the image of the relation RNS of fᵣ_{ₒ}ᵣ is of the same type as [symbol] and furthermore for (each rεω) φᵣ={r: left(r)ε{left(r){ν→ [symbol] (ν):apex(ν)εPI(N), N⊂apex(left(r)) [symbol] ({apex(right(s)): sεω}∪{apex(rₒ)}), ν matches left(r)}, and for each r̅in each φᵣ ε [symbol] (rₒ, [symbol] ᵣ_{ₒ},{fᵣ_{ₒ}ᵣ: rεω}) e→right(r) is manoeuvre mightiness and arity mightiness saving, whenever e∈right(r(r)). Let Q be such that R→Q is of the same type as [symbol] We denote
[symbol] =U(Pₐ(rₒ, [symbol] , {fᵣ _{₀} ᵣ: r∈ω}):ω∈ [symbol] (r←φᵣ:r∈ω, ω∈ [symbol] )).
   Let p=rₒ [symbol] ̂. We define a cover reversely labeling RNS
ZRNS( [symbol] ,rₒ)={μ→ν: μ matches right(p), apex(μ)=apex(right(p)) [symbol] apex(left(q)),
   ν matches right(s), apex(ν)=apex(right(s)) [symbol] apex(left(t)),
   p, q ε ω, S, t,ε φᵣ, φᵣεP_{ω}(rₚ, [symbol] , {fᵣ_{ₒ}ᵣ: rεω{),ωε [symbol] .}.
      Now we say that ZRNS( [symbol] ,rₒ)̂(p→Q) is a GMA of rₒ→R in regard to [symbol] and [symbol] , denoted GMA(rₒ→R, [symbol] ). If we want to emphasize the importance of generalized partition relations, notation GMA(rₒ→R, [symbol] ) is used, where [symbol] =( [symbol] ,{fᵣ_{ₒ}ᵣ: rεω,ωε [symbol] }). We say that
{GMA(r, [symbol] ): rεφ, φε [symbol] (r←GMA(r, [symbol] f̅_{left(r)ω}) :rεφ, φε [symbol] )}
   is a generalized macro RNS of [symbol] in regard to [symbol] and [symbol] (={ f̅_{left(r)} [symbol] : rεφ, φε [symbol] }; we reserve the notation for that purpose), denoted GMA ( [symbol] ) or [symbol] If we do not want to specify partition relations we simply denote [symbol] . In this connection we want to make noticeable that if [symbol] would be allowed to be manoeuvre deleting, there does not always exist GMA for a given rule.
   [5.4.1] Let [symbol] be a set of RNS:es and [symbol] a TD over [symbol] and let [symbol] be a GC_{d}RNS, whenever [symbol] We define a generalized macro TD of [symbol] in regard to ( [symbol] ,f)( [symbol] ) (={( [symbol] ): [symbol] }), GMA( [symbol] ( [symbol] ,f)( [symbol] )), denoted also [symbol] , such that
[symbol] = [symbol] : [symbol] is a GC_{d}RNS, [symbol] ):
   denoted [symbol] , if it is not wanted to specify partition relations. We say that [symbol] is a generalized micro TD of [symbol] , and denote it [symbol] . Furthermore for each TD [symbol] we denote
[symbol] (T)={ [symbol] : [symbol] is of type T} and
[symbol] −(T)={ [symbol] : [symbol] is a type of T},
   whenever Tε{PRNS, GPRNS, C_{d}RNS, GC_{d}RNS}. Notice that because GC_{d}RNS:es are genuine generalizations of GPRNS:es we have equations

[symbol]

(GPRNS)⊂ [symbol] (GC_{d}RNS) and [symbol] (GPRNS) ⊂ [symbol] (GC_{d}RNS).

[5.4.1.1] Clearly we can generalize theorem 3.2.1 as follows:

### Theorem 5.4.0. Theorem 3.2.1(RNS←TD,PRNS←GPRNS).

[5.4.2] Theorem 5.4.1. For each C_{d}RNS and on the other hand GC_{d}RNS, [symbol] and each RNS [symbol] there is GMA( [symbol] ), and such PRNS and GPRNS respectively, [symbol] , that
[symbol] ( [symbol] )̂= [symbol]
   Proof. Let rₒ←R be in a rule of [symbol] , and let net a be as in definition [5.4.0]. Because the image set of the relation RNS of each single partition relation is manoeuvre mightiness and arity mightiness saving, then RNS [symbol] for which
[symbol] =∪(F_{ω}(rₒ, [symbol] ᵣ_{ₒ}{fᵣ_{ₒ}ᵣ: rεω}): ωε [symbol] (r→φᵣ: rεω,ωε [symbol] U)),
   where for each ωε [symbol] , F_{ω}(rₒ, [symbol] , {fᵣ_{ₒ}ᵣ: rεω}) is the set of rules ν→ [symbol] (ν), ν→fᵣ_{ₒ}ᵣ(ν) defined as in the definition of r, is a GPRNS of net al. Because [symbol] is distinct from right sides and not manoeuvre deleting, so regardless of which type of interacting RNS in our theorem is chosen we obtain
a [symbol] ̂=a [symbol] ̂=a [symbol] ZRNS( [symbol] ,rₒ)̂,
   and the claim of our theorem follows from theorem 5.4.0. See FIG. 5.4.2. □
   FIG. 5.4.2 In the figure we have [symbol] =(α→α′)(β→β′)(γ→γ′)(δ→δ′), cεa [symbol] ̂, c [symbol] ¹̂εCov(a), areas in c having a dot are ranked letters (e.g. |{\tilde{α}′,σ):σεL°(\tilde{α}′)}|=8), and [symbol] symbolies the apex of [symbol] whenever [symbol] is a net. In the picture the apexes of the left and the right sides of p₂, p₃ and p₄, respectively, are supposed to be one upon another, the right sides uppermost.
   ZRNS( [symbol] ,rₒ)̂(p→Q) is a GMA of rₒ→R. Furthermore we have
   ZRNS( [symbol] ,rₒ)̂⊃r₁r₂r₃r₄, where
   apex(left(r₁))=\tilde{δ}′, apex(right(r₁))=\tilde{δ}′; apex(left(r₂))=\tilde{γ}′ [symbol] \tilde{δ}′, apex(right(r₂))=\tilde{γ}′ [symbol] \tilde{δ}, apex(left(r₃))=\tilde{β}′ [symbol] (\tilde{γ}β\tilde{δ}), apex(right(r₃))=\tilde{β}′ [symbol] (\tilde{γ}β\tilde{δ});
   apex(left(r₄))=\tilde{α}′ [symbol] (\tilde{β}∪\tilde{γ}∪\tilde{δ}), apex(right(r₄))=\tilde{α}′ [symbol] (\tilde{β}∪\tilde{γ}∪\tilde{δ}). [symbol]
   ̂p₁p₂p₃p₄, where apexes of left and right sides in p₂, p₃ and p₄ are shaded, and all letters in the right sides of p₁,p₂,p₃ and p₄ are denoted with dots.
   apex(left(p₁))=\tilde{α}, apex(right(p₁))=\tilde{α}′; apex(left(p₂))=\tilde{β}, apex(right(p₂))=\tilde{β}′;
   apex(left(p₃))=\tilde{γ}, apex(right(p₃))=\tilde{γ}′; apex(left(p₄))=\tilde{δ}, apex(right(p₄))=\tilde{δ}′.
   As each Cartesian power of each net is a net, theorem 5.4.1 yields the following theorem:
   Theorem 5.4.2. For each GC_{d}RNS [symbol] and each TD [symbol] over set of RNS:es, [symbol] there is [symbol] , and such GPRNS [symbol] that
[symbol] ̂( [symbol] )̂= [symbol] .
   [5.5.0] Fig. of Memory Hunting illustrates iterative process of probing known transducers in memory by cover rewriting systems in order to transform them by cover reversely labelling RNS:es. In the figure a, b, c, b₁, c₁, b₂, c₂ and b₃ are nets.
   [5.5.1] Fig. of Process Summarization (Automated Problem Solving System) RPG describes the relations between known TD:es [symbol] and TD:es [symbol] (b, [symbol] ) solving given problem (b, [symbol] ) belonging to language [symbol] recognized by [symbol] .

The mother graph b of given problem (b, [symbol] ) is first transformed by right sides distinct cover renetting to net β for which we construct an abstract sister, here α, one of the substances of which has a partition being in bijection with a partition of one of the substances of β. From known transducer ( [symbol] ), enabling to construct interacting (G)PRNS:es between g and α° and on the other hand between g and β°, we then construct (parallel ( [symbol] ) [symbol] , and by iteration we reach for our original problem (b, [symbol] ) a presolution [symbol] (b, [symbol] ), which finally is a desired solution, if first of all [symbol] accepts the product that is product (b, [symbol] ) [symbol] (b, [symbol] ) ε [symbol] and moreover the product fulfills limit demands [symbol] .

Being due to corollary 3.2 we may direct consider result [symbol] (b, [symbol] ) macro(micro( [symbol] )) via some substance f for mother graphs a and b (substances for abstract sisters α and β), but in the case the interacting RNS:es [symbol] and [symbol] would be very difficult or even impossible to acquire, if a or b is undenumerable (and actually even if the mightiness of one of them is considerable although denumerable).

Symbol θ stands for a generalized abstraction relation, and [symbol] are interacting RNS:es, and furthermore TD:es [symbol] and parallel ( [symbol] ) are parallel with each other, [symbol] a being macro of [symbol] and (parallel( [symbol] )) [symbol] being micro of parallel [symbol] .

The dots in nets a° and β° in the figure represent letters (as results of GPRNS:es) and the small squares in nets a, b, a° and β° stand for matching areas (the sets of redexes) of rules in RNS:es of transducers. Symbols η, κ, λ and λ are enclosements.

[5.6.1] The generalized abstraction relation in regard to type T of interacting RNS, GAR(T), (e.g. Tε{PRNS,GPRNS,C_{d}RNS,CRNS,GC_{d}RNS,GCRNS}), (in short abstraction relation of toe T) is such a binary relation of the pairs of nets, where for each pair (here (s,t)) there is such net c and interacting RNS:es [symbol] and [symbol] of type T, that
c [symbol] ̂=s and c [symbol] ̂=t.
   Nets s and t are said to be abstract sisters of type T with each other, c being a substance of s and t. Notice that GAR is a genuine generalization for abstraction relation AR, and that AR=GAR(PRNS).
   [5.6.2] Clause. “A characterization of generalized abstraction relation GAR(CRNS)”. Let a and b be two nets and let θ be GAR(CRNS). Then
a θb [symbol] |OS(a)|=|OS(b)|.
   Proof. Theorem 3.1 and clause 5.2. □
   [5.6.2.1] We can straightforwardly widen the definition for “parallel” to deal with interacting RNS:es of type GPRNS, C_{d}RNS and GC_{d}RNS instead of solely dealing with type PRNS. Therefore we clearly have the results for GAR(C_{d}RNS) as is obtained for AR: corollaries 3.1 and 3.2, and result [3.1.9], parallel-theorem, lemmas [3.4.1] and [3.4.2], theorem [3.4.1], and result [3.4.5].
   [5.6.3] Clause. “Characterization of GAR”. Let Tε{GC_{d}RNS,GCRNS} and let s and t be nets. Then s and t are abstract sisters of type T, if and only if there exist such interacting RNS:es [symbol] and [symbol] of type T that
(∃Aₛ, εPar(s [symbol] )̂) and (∃AₜεPar(t [symbol] )̂) there is a bijection between Aₛ and Aₜ.
   Proof. FIG. 5.6.3 describes a typical phase in iteration of the general case for interacting RNS of type GCRNS. □
   In FIG. 5.6.3 a, b, α, β and γ are nets and x, y and z are frontier letters, z is chosen to be connected to the same net as x, o characterizes occupied and α stands for unoccupied.
   [5.7.1] Let θ be a relation in the set of the nets. We say that θ is a generalized congruent relation of type T (e.g. Tε{PRNS,GPRNS,C_{d}RNS,CRNS,GC_{d}RNS,GCRNS}), if there is in force:
a θ b [symbol] aφ^{a}θb ^{b} whenever φ^{a} and φ^{b} are renetting rules in RNS:es of type T.
   Each generalized congruent relation of type T, which is an equivalence relation, is entitled generalized congruence relation of type T. The set of all generalized congruence relations of type T is denoted GCg(T).
   [5.7.2] Theorem. GAR(T)εGCg(T), whenever Tε{PRNS,CRNS}.
   Proof. Clause [5.6.2].□
   [5.7.3] Theorem. GAR(T) E GCg(T), whenever Tε{GPRNS,GCRNS}.
   Proof. Because there is only one rule to reverse, it is not required demand “distinct from right sides” and therefore clause 5.1 yields that GAR(GCRNS) is congruent. Equivalence followes from characterization clause 5.6.3. □
   [5.7.4] CONCLUSION. Hence there is in force the same generalization of results of AR for GAR(GC_{d}RNS) as we introduced for GAR(C_{d}RNS) in [5.6.2.1].

1. A method for automated problem solving comprising the steps:
i. converting any problem to a triple: the mother graph representing the subject of the problem, the recognizer determining if the problem is solved, and the limit demands for the proper type of solutions, and
ii. A) in order to control comprehensiveness of the searching process choosing the type of the desired interacting cover rewriting system from the set consisting of partition renetting system, generalized partition renetting system, cover renetting system distinct from right sides and generalized cover renetting system distinct from right sides, and
B) transforming said mother graph by said cover renetting system into the graphs covered with abstract parts, and
iii. A) by partition relations constructing cover reversely labelling renetting systems to be applied to said graphs covered with abstract parts thus yielding graphs as the cover result of said generalized partition renetting system for said mother graph, and
B) producing abstract sisters of said type being in generalized abstraction relation of said type with said graphs covered with abstract parts by
a) constructing graphs, the amount of the positions of outside arities of which being the same as of said cover result of said interacting cover renetting system for said mother graph, if said type is partition renetting system or cover renetting system distinct from right sides, and
b) constructing graphs a substance of which has a partition being in bisection with a partition in a substance of said cover result of said interacting cover renetting system for said mother graph, if said type is generalized cover renetting system distinct from right sides, and
iv. A) applying known transducers for substances of said abstract sisters, the nodes of said known transducers being rewrite systems and said known transducers solving problems the mother graphs of which have common parts with said substances, and
B) a) constructing generalized altering macros for said known transducers, and
b) simultaneously for rule after rule in said macros constructing altering transducers parallel with said macros, and
C) applying said parallel altering transducers for said cover result for said mother graph, and on the other hand applying said macros of said known transducers for said abstract sisters of said type to get graphs being in said generalized abstraction relation with each other, and
V. A) a) constructing micros for said parallel altering transducers, and
b) as the right solutions for a given problem choosing those ones of said micros which fulfil said limit demands and produce graphs recognized by said recognizer, and
B) in the case said mother graph is denumerable, those said right solutions containing for said given problem all those solutions which are not contents expanding.
